(19) United States
(12) Patent Application Publication
(10) Pub. No.: US 2024/0085773 A1
(43) Pub. Date: Mar. 14, 2024

(54) FLUORESCENCE EMITTING MODULE AND LIGHT EMITTING DEVICE

(71) Applicant: Panasonic Intellectual Property Management Co., Ltd., Osaka (JP)

(72) Inventors: Yosuke HONDA, Nara (JP); Shinichi KITAOKA, Osaka (JP); Noriyasu NAKASHIMA, Osaka (JP); Yoshiyuki TAKAHIRA, Kyoto (JP)

(73) Assignee: Panasonic Intellectual Property Management Co., Ltd., Osaka (JP)

(21) Appl. No.: 18/039,109

(22) PCT Filed: Oct. 20, 2021
(86) PCT No.: PCT/JP2021/038708

§ 371 Date: May 26, 2023

(30) Foreign Application Priority Data
Dec. 4, 2020 (JP) 2020-202083
Jun. 3, 2021 (JP) 2021-093347

(51) Int. Cl. G03B 21/20; C09K 11/77; G02B 26/00; G03B 21/16

(52) U.S. Cl. CPC G03B 21/204; C09K 11/7769; G02B 26/008; G03B 21/16

(57) ABSTRACT

A fluorescence emitting module includes: a fluorescent substrate consisting essentially of a sintered fluorescent substance that includes a fluorescent material; and a rotator that rotates the fluorescent substrate about an axis extending in a thickness direction of the fluorescent substrate.

### TECHNICAL FIELD

The present invention relates to a fluorescence emitting module and a light emitting device in which the fluorescence emitting module is used.

### BACKGROUND ART

A conventional fluorescence emitting module that receives excitation light and emits fluorescence has been known. Such a fluorescence emitting module is applied to a light emitting device such as a projector, for example.

As an example of a fluorescence emitting module, Patent Literature (PTL) 1 discloses a light source device that includes a light emitter that emits excitation light, a fluorescence generator that is excited by the excitation light and generates fluorescence, and a substrate for fluorescence that is formed of a plate-shaped glass member and supports the fluorescence generator, for instance. In the fluorescence emitting module, the excitation light enters the substrate for fluorescence from the atmosphere. Furthermore, the excitation light that has entered the substrate for fluorescence passes through the substrate for fluorescence and enters the fluorescence generator, so that fluorescence is generated by the fluorescence generator.

### CITATION LIST

### Patent Literature

[PTL 1] Japanese Unexamined Patent Application Publication No. 2012-9242

### SUMMARY OF INVENTION

### Technical Problem

In the fluorescence emitting module, a portion of the excitation light that enters the substrate for fluorescence from the atmosphere is reflected toward the atmosphere, due to a difference between the index of refraction of the substrate for fluorescence and the index of refraction of the atmosphere. As a result, as compared with the case where a portion of excitation light is not reflected, excitation light that enters the fluorescence generator decreases, and thus fluorescence generated in the fluorescence generator also decreases. Thus, the fluorescence emitting module has a problem that efficiency of light usage is low.

In the fluorescence emitting module, the fluorescence generator on the substrate for fluorescence is formed of a fluorescent material and a transparent resin. In the fluorescence generator, the fluorescent material generates the highest heat due to being irradiated with excitation light. The heat generated by the fluorescent material is conducted through the transparent resin and dissipated. However, the thermal conductivity of the transparent resin is low (or in other words, the thermal resistance is high), and thus it is difficult to efficiently dissipate heat generated by the fluorescent material. This heat causes a phenomenon in which less fluorescence is generated (a so-called thermal quenching phenomenon), and thus the chromaticity of light output by the fluorescence emitting module greatly changes. Furthermore, a linear expansion coefficient of the transparent resin is greatly different from the linear expansion coefficients of the fluorescence generator and the substrate for fluorescence, and thus the fluorescence generator is readily detached from the substrate for fluorescence. The fluorescence emitting module has a problem that its reliability is low, due to such a change in chromaticity and detachment, for instance.

In view of this, an object of the present invention is to provide a fluorescence emitting module and a light emitting device that achieve high efficiency of light usage and are highly reliable.

### Solution to Problem

A fluorescence emitting module according to an aspect of the present invention includes: a fluorescent substrate consisting essentially of a sintered fluorescent substance that includes a fluorescent material; and a rotator that rotates the fluorescent substrate about an axis extending in a thickness direction of the fluorescent substrate.

A fluorescence emitting module according to an aspect of the present invention includes: a fluorescent substrate consisting essentially of a sintered fluorescent substance that includes: a fluorescent material; and a highly heat-conductive material having a thermal conductivity in a range from 100 W/m·K to 300 W/m·K.

A light emitting device according to an aspect of the present invention includes the fluorescence emitting module stated above.

### Advantageous Effects of Invention

According to the present invention, a fluorescence emitting module and a light emitting device that achieve high efficiency of light usage and are highly reliable can be provided.

### BRIEF DESCRIPTION OF DRAWINGS

FIG. 1 is a perspective view of a fluorescence emitting module according to Embodiment 2.

FIG. 2 is a cross sectional view illustrating a cut surface of a portion of the fluorescence emitting module taken along line II-II in

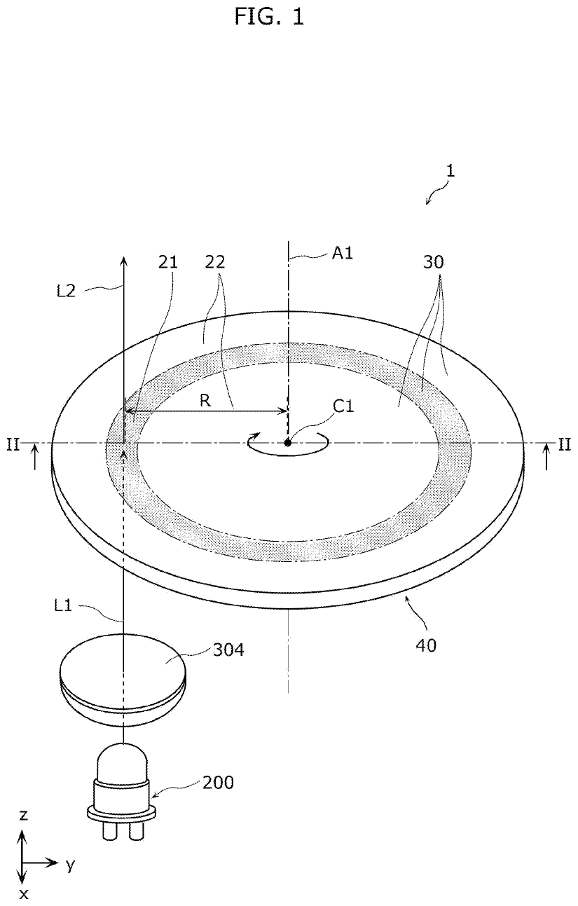

FIG. 1.

FIG. 3 is a perspective view illustrating an appearance of a projector according to Embodiment 1.

FIG. 4A illustrates a fluorescence emitting module in the projector according to Embodiment 1.

FIG. 4B illustrates efficiency of energy of transmitted light according to Embodiment 1.

FIG. 5A is a perspective view of a metal mold for manufacturing a fluorescent substrate according to Embodiment 1.

FIG. 5B illustrates a relation between the Ce concentration in YAG:Ce and the thickness of a fluorescent substrate according to Embodiment 1.

FIG. 5C illustrates a relation between the Ce concentration in YAG:Ce and the temperature of the fluorescent substrate according to Embodiment 1.

FIG. 5D illustrates a relation between the Ce concentration and a spot size magnification of the fluorescent substrate according to Embodiment 1.

FIG. 6 is a cross sectional view of a fluorescent substrate according to Another Example 1 of Embodiment 2.

FIG. 7 is a cross sectional view of a fluorescent substrate according to Another Example 2 of Embodiment 2.

FIG. 8 is a perspective view of the fluorescence emitting module according to Embodiment 1.

FIG. 9 is a cross sectional view illustrating a cut surface of a portion of the fluorescence emitting module taken along line IX-IX in FIG. 8.

FIG. 10 is a schematic diagram illustrating a configuration of the projector according to Embodiment 1.

FIG. 11 is a perspective view of a fluorescence emitting module according to Embodiment 3.

FIG. 12 is a cross sectional view illustrating a cut surface of a portion of the fluorescence emitting module taken along line XII-XII in FIG. 11.

FIG. 13 is a perspective view of a fluorescence emitting module according to Embodiment 4.

FIG. 14 is a perspective view of a metal mold for manufacturing a fluorescent substrate according to Embodiment 4.

FIG. 15 is a perspective view of a fluorescence emitting module according to Embodiment 5.

FIG. 16 is a cross sectional view illustrating a cut surface of a portion of the fluorescence emitting module taken along line XVI-XVI in FIG. 15.

FIG. 17 is a perspective view of a fluorescence emitting module according to Embodiment 6.

### DESCRIPTION OF EMBODIMENTS

The following describes in detail a fluorescence emitting module, for instance, according to embodiments of the present invention, with reference to the drawings.

Note that the embodiments described below each show a general or specific example. The numerical values, shapes, materials, elements, the arrangement and connection of the elements, manufacturing processes, and the processing order of the manufacturing processes, for instance, described in the following embodiments are examples, and thus are not intended to limit the present invention.

In addition, the drawings are schematic diagrams, and do not necessarily provide strictly accurate illustration. Accordingly, scaling, for example, is not necessarily consistent throughout the drawings. In the drawings, the same sign is given to substantially the same configuration, and a redundant description thereof is omitted or simplified.

In the Specification, a term that indicates a relation between elements such as parallel or orthogonal, a term that indicates the shape of an element such as circular, and a numerical range do not necessarily have only strict meanings, and also cover substantially equivalent ranges that include a difference of about several percent, for example.

In the Specification and the drawings, the x axis, the y axis, and the z axis represent three axes of a three-dimensional orthogonal coordinate system. In the embodiments, the direction parallel to the direction of an axis is the z axis, and two axes orthogonal to the z axis are the x axis and the y axis.

### Embodiment 1

### [Configuration of Fluorescence Emitting Module]

First, a configuration of fluorescence emitting module 1c according to the present embodiment is to be described with reference to the drawings. FIG. 8 is a perspective view of fluorescence emitting module 1c according to the present embodiment. FIG. 9 is a cross sectional view illustrating a cut surface of a portion of fluorescence emitting module 1c taken along line IX-IX in FIG. 8.

As illustrated in FIG. 8 and FIG. 9, fluorescence emitting module 1c includes fluorescent substrate 10c consisting essentially of a sintered fluorescent substance, anti-reflective layer 30, blue-transmitting dichroic multi-layer film 40, rotator 100, fourth optical element 304, and two light emitters 200. Note that FIG. 8 illustrates one light emitter 200 for convenience. One light emitter 200 is similarly illustrated in some of the drawings described below. Fluorescence emitting module 1c may include single light emitter 200. Fluorescence emitting module 1c is used in a light emitting device typified by a projector and an illumination device. In the present embodiment, description is given using, as an example, a projector in which fluorescence emitting module 1c is used. Fluorescent substrate 10c is used as light-transmissive fluorescent wheel that receives excitation light L1 and emits transmitted light L2 that includes fluorescence. Transmitted light L2 is used as projection light output by the projector.

The following describes elements included in fluorescence emitting module 1c.

### <Description of Light Emitters>

Light emitter 200 is a light source that emits excitation light L1. Excitation light L1 excites fluorescent substrate 10c that includes a sintered fluorescent substance. In other words, excitation light L1 excites a fluorescent material included in the sintered fluorescent substance included in fluorescent substrate 10c. Note that FIG. 9 shows a side view of light emitter 200. Light emitter 200 is, for example, a semiconductor laser light source or a light emitting diode (LED) light source, and emits excitation light L1 having a predetermined color (wavelength) by being driven by a driving current.

In the present embodiment, light emitters 200 are semiconductor laser light sources. Note that semiconductor laser elements included in light emitters 200 are GaN-based semiconductor laser elements (laser chips) consisting essentially of a nitride semiconductor material, for example. In the present embodiment, light emitters 200 that are semiconductor laser light sources are collimator lens integrated light emitting devices of a TO-CAN type. Note that two light emitters 200 may be multi-chip lasers as disclosed in Japanese Unexamined Patent Application Publication No. 2016-219779 or may each include a collimator lens and a TO-CAN separately.

As an example, light emitters 200 each emit, as excitation light L1, a laser beam in a range from near ultra violet light to blue light, which has a peak wavelength in a range from 380 nm to 490 nm. At this time, excitation light L1 has a peak wavelength of 455 nm, for example, and is blue light.

### <Description of Rotator>

Rotator 100 is a member that rotates fluorescent substrate 10c about axis A1 that extends in the thickness direction (the z-axis direction) of fluorescent substrate 10c, and is a motor as an example. More specifically, in the present embodiment, rotator 100 rotates fluorescent substrate 10c, anti-reflective layer 30, and blue-transmitting dichroic multi-layer film 40 about axis A1 in the direction of the arrow illustrated in FIG. 8. When the center of fluorescent substrate 10c that is circularly shaped in the plan view is center point C1, axis A1 passes through center point C1 and thus penetrates through fluorescent substrate 10c. Here, a view of fluorescence emitting module 1c in the positive z-axis direction is the plan view. Note that FIG. 9 shows illustration that omits internal components of rotator 100.

As illustrated in FIG. 9, fluorescent substrate 10c is provided at a position that overlaps such rotator 100 in the plan view.

### <Fourth Optical Element>

Fourth optical element 304 is an optical member that controls optical paths of excitation light L1 output from two light emitters 200. As an example, fourth optical element 304 is a lens for collecting transmitted light L2. Note that FIG. 9 shows a side view of fourth optical element 304.

### <Description of Fluorescent Substrate>

Fluorescent substrate 10c is a circularly shaped substrate as described above, which consists essentially of a sintered fluorescent substance that includes a fluorescent material. Thus, fluorescent substrate 10c has a disc shape having a flat surface. Specifically, here, fluorescent substrate 10c is made of a sintered fluorescent substance, and the sintered fluorescent substance is made of a fluorescent material that is a principal component.

Note that here, the sintered fluorescent substance in the present embodiment is to be described.

A sintered fluorescent substance is a baked body obtained by baking raw-material powder of the above fluorescent material that is a principal component (an example of which is a granulated body obtained by granulating raw-material power of the fluorescent material) at a temperature lower than the melting point of the fluorescent material. During the baking process, raw-material powder particles of the sintered fluorescent substance are bonded. Accordingly, the sintered fluorescent substance requires almost no binder for bonding granulated bodies. More specifically, the sintered fluorescent substance does not need a binder at all. An example of a binder is a transparent resin in PTL 1 stated above. Further, a known material such as an Al₂O₃ material or a glass material (that is, SiO_{d} (0<d≤2)) is used for the binder. Note that similarly, not just the binder, the sintered fluorescent substance needs almost no material (hereinafter, another material) other than a fluorescent material, or more specifically, does not require none of such another material.

For example, when the entire volume of the sintered fluorescent substance is considered to be 100 vol %, the volume of the fluorescent material may occupy 70 vol % or more of the entire volume of the sintered fluorescent substance. Further, the volume of the fluorescent material occupies preferably 80 vol % or more, more preferably 90 vol % or more, or yet more preferably 95 vol % or more of the entire volume of the sintered fluorescent substance.

Note that stated differently, when the entire volume of the sintered fluorescent substance is considered to be 100 vol %, the volume of another material (for example, a binder) may occupy less than 30 vol % of the entire volume of the sintered fluorescent substance. Further, the volume of another material (for example, a binder) occupies preferably less than 20 vol %, more preferably less than 10 vol %, or yet more preferably less than 5 vol % of the entire volume of the sintered fluorescent substance.

If the volume percent of another material in the entire volume of the sintered fluorescent substance is high (or in other words, the proportion of the volume of another material is high), phonon scattering occurs due to a defect present at the interface between the fluorescent material and another material. As a result, thermal conductivity of the sintered fluorescent substance decreases. In particular, if the volume of another material occupies 30 vol % or more, thermal conductivity significantly decreases. Further, more non-radiative recombination occurs at the interface, and efficiency of light emission decreases. In other words, the lower the volume percent of another material (or in other words, the proportion of the volume of another material) in the entire volume of the sintered fluorescent substance is, the higher the thermal conductivity and efficiency of light emission become. The sintered fluorescent substance according to the present invention includes another material, the volume of which is less than 30 vol % in the entire volume of the sintered fluorescent substance.

Here, a fluorescent material is to be described. The fluorescent material consists essentially of a crystalline phase having a garnet structure, for example. The garnet structure is a crystalline structure represented by the general formula A₃B₂C₃O₁₂. One or more rare earth elements such as Ca, Y, La, Ce, Pr, Nd, Sm, Eu, Gd, Tb, and Lu are used as element A, and one or more elements such as Mg, Al, Si, Ga, and Sc are used as element B, and one or more elements such as Al, Si, and Ga are used as element C. Examples of such a garnet structure include yttrium aluminum garnet (YAG), lutetium aluminum garnet (LuAG), lutetium calcium magnesium silicon garnet (Lu₂CaMg₂Si₃O₁₂), and terbium aluminum garnet (TAG). In the present embodiment, the fluorescent material includes the crystalline phase represented by (Y₁₋ₓCeₓ)₃Al₂Al₃O₁₂ (that is, (Y₁₋ₓCeₓ)₃Al₅O₁₂) (0.0001≤x<0.1), stated differently, YAG:Ce.

When the fluorescent material includes YAG:Ce, there are cases where Al₂O₃ is used as the raw material. In this case, there are cases where Al₂O₃ remains as an unreacted raw material in the sintered fluorescent substance. However, Al₂O₃ that is an unreacted raw material is different from the binder described above. If the entire volume of the sintered fluorescent substance is considered to be 100 vol %, the volume of Al₂O₃ that is an unreacted raw material in the entire volume of the sintered fluorescent substance is 5 vol % or less.

Note that the crystalline phase included in the fluorescent material may be a solid solution that includes a plurality of garnet crystalline phases having different chemical compositions. An example of such a solid solution is a solid solution ((1−a)(Y₁₋ₓCeₓ)₃Al₅O₁₂·a(Lu_{1-y}Ce_{y})₃Al₂Al₃O₁₂ (0<a<1)) that includes a garnet crystalline phase represented by (Y₁₋ₓCeₓ)₃Al₂Al₃O₁₂ (0.001≤x<0.1) and a garnet crystalline phase represented by (Lu_{1-y}Ce_{y})₃Al₂Al₃O₁₂ (0.001≤y<0.1). Further, an example of such a solid solution is a solid solution ((1−b)(Y₁₋ₓCeₓ)₃Al₂Al₃O₁₂·b(Lu_{1-z}Ce_{z})₂CaMg₂Si₃O₁₂ (0<b<1)) that includes a garnet crystalline phase represented by (Y₁₋ₓCeₓ)₃Al₂Al₃O₁₂ (0.001≤x<0.1) and a garnet crystalline phase represented by (Lu_{1-z}Ce_{z})₂CaMg₂Si₃O₁₂ (0.0015≤z<0.15). The fluorescent material includes a solid solution that includes a plurality of garnet crystalline phases having different chemical compositions, and thus the spectrum of fluorescence emitted by the fluorescent material is further increased and includes more green light components and more red light components. Accordingly, a projector that emits projection light having a wide color gamut can be provided.

The crystalline phases included in the fluorescent material may include a crystalline phase having a chemical composition that deviates from the crystalline phase represented by the above-stated general formula A₃B₂C₃O₁₂. An example of such a crystalline phase is (Y₁₋ₓCeₓ)₃Al_{2+δ}Al₃O₁₂ (where δ is a positive number) that includes richer Al than the crystalline phase represented by (Y₁₋ₓCeₓ)₃Al₂Al₃O₁₂ (0.001≤x<0.1). Further, another example of such a crystalline phase is (Y₁₋ₓCeₓ)_{3+ƒ}Al₃O₁₂ (where ƒ is a positive number) that includes richer Y than the crystalline phase represented by (Y₁₋ₓCeₓ)₃Al₂Al₃O₁₂ (0.001≤x<0.1). Such crystalline phases have chemical compositions that deviate from the crystalline phase represented by the general formula A₃B₂C₃O₁₂, but maintain the garnet structure.

Furthermore, the crystalline phases included in the fluorescent material may include a different crystalline phase having a structure other than the garnet structure.

In the present embodiment, the fluorescent material that includes YAG:Ce receives, as excitation light L1, light that enters fluorescent substrate 10c from the z-axis negative direction and emits fluorescence. More specifically, the fluorescent material is irradiated with light emitted by light emitters 200 as excitation light L1, and thus emits fluorescence as wavelength-converted light. Hence, the wavelength-converted light emitted from the fluorescent material has a wavelength longer than the wavelength of excitation light L1.

In the present embodiment, wavelength-converted light emitted from the fluorescent material includes fluorescence that is yellow light. For example, the fluorescent material absorbs light having a wavelength in a range from 380 nm to 490 nm, and emits fluorescence that is yellow light and has a peak wavelength in a range from 490 nm to 580 nm. Since the fluorescent material includes YAG:Ce, the fluorescent material can readily emit fluorescence having a peak wavelength in a range from 490 nm to 580 nm.

A wavelength of a portion of excitation light L1 that has entered the fluorescent material is converted by the fluorescent material as described above, and the portion of excitation light L1 passes through fluorescent substrate 10c. A wavelength of another portion of excitation light L1 is not converted by the fluorescent material, and the other portion of excitation light L1 passes through fluorescent substrate 10c. Transmitted light L2 passing through fluorescent substrate 10c includes fluorescence that is yellow light having a converted wavelength and excitation light L1 that is blue light having a wavelength not converted. Thus, transmitted light L2 is a combination of such light, and is while light. For example, in transmitted light L2, if the balance between fluorescence and excitation light L1 is no longer maintained, chromaticity of transmitted light L2 changes. More specifically, if fluorescence decreases, a proportion of excitation light L1 increases, and thus a proportion of blue light in transmitted light L2 increases.

As illustrated in FIG. 8, in the present embodiment, excitation light L1 is emitted onto a position at radius R from center point C1 of fluorescent substrate 10c.

### <Description of Coating Layer>

### <Blue-Transmitting Dichroic Multi-Layer Film>

Blue-transmitting dichroic multi-layer film 40 is located on fluorescent substrate 10c in the z-axis negative direction. Blue-transmitting dichroic multi-layer film 40 is a layer having transmissive and reflective properties of transmitting excitation light L1 and reflecting fluorescence. In the present embodiment, blue-transmitting dichroic multi-layer film 40 is a layer having transmissive and reflective properties of transmitting blue light and reflecting yellow light.

Specifically, blue-transmitting dichroic multi-layer film 40 is a dichroic layer that includes a dielectric multi-layer film, for instance. Blue-transmitting dichroic multi-layer film 40 controls a dielectric material included in the dichroic layer and/or a configuration of the multi-layer film, thus having a predetermined reflectance for a predetermined wavelength and a highly transmissive property at a blue wavelength.

For example, if such blue-transmitting dichroic multi-layer film 40 is not provided, a portion of fluorescence generated by the fluorescent material is emitted from fluorescent substrate 10c in the z-axis negative direction and cannot be used as projection light of the above-stated projector. Since blue-transmitting dichroic multi-layer film 40 is provided, the above portion of the light is reflected in the z-axis positive direction by blue-transmitting dichroic multi-layer film 40. Thus, the entire fluorescence generated by the fluorescent material in fluorescent substrate 10c readily travels in the z-axis positive direction. Thus, efficiency of light usage of fluorescence emitting module 1c can be increased. Further, blue-transmitting dichroic multi-layer film 40 yields effects as an anti-reflective film for excitation light L1 (blue light), and thus can increase the amount of excitation light L1 that enters fluorescent substrate 10c, as compared with the case where blue-transmitting dichroic multi-layer film 40 is not provided.

### <Anti-Reflective Layer>

Furthermore, anti-reflective layer 30 is located on fluorescent substrate 10c in the z-axis positive direction.

Anti-reflective layer 30 reduces, or more specifically, prevents reflection of transmitted light L2. Thus, anti-reflective layer 30 prevents transmitted light L2 traveling in the z-axis positive direction from being reflected and traveling in the z-axis negative direction.

Anti-reflective layer 30 decreases the reflectance of transmitted light L2 emitted from fluorescence emitting module 1c, or stated differently, improves a transmittance of transmitted light L2 and increases transmitted light L2 emitted from fluorescence emitting module 1c. As a result, transmitted light L2 that can be used as, for example, projection light of the projector increases. Thus, efficiency of light usage of fluorescence emitting module 1c can be increased.

For example, anti-reflective layer 30 may include a dielectric film or may have a minute rough structure (a so-called moth-eye structure) having a cycle shorter than the wavelength of light in a visible light range. When anti-reflective layer 30 is a dielectric film, anti-reflective layer 30 can be readily manufactured since anti-reflective layer 30 includes at least one inorganic compound. In this case, anti-reflective layer 30 includes one or more inorganic compounds selected from among SiO₂, TiO₂, Al₂O₃, ZnO, Nb₂O₅, and MgF, for instance.

Although FIG. 8 and FIG. 9 illustrate a configuration in which anti-reflective layer 30 and blue-transmitting dichroic multi-layer film 40 are provided, fluorescence emitting module 1c may not include anti-reflective layer 30 or blue-transmitting dichroic multi-layer film 40. In this case, rotator 100 and fluorescent substrate 10c are in contact with each other with an adhesive member being provided therebetween.

The plan-view shapes of anti-reflective layer 30 and blue-transmitting dichroic multi-layer film 40 are the same as the shape of fluorescent substrate 10c and are circular. Although not illustrated, anti-reflective layer 30 and blue-transmitting dichroic multi-layer film 40 may be disposed, overlapping a position irradiated with excitation light L1 in the plan view, and may have an annular ring shape. At this time, the center of the annular ring shape overlaps center point C1 of fluorescent substrate 10c.

Anti-reflective layer 30 and blue-transmitting dichroic multi-layer film 40 are sufficiently thin as compared with fluorescent substrate 10c. For example, anti-reflective layer 30 and blue-transmitting dichroic multi-layer film 40 each have a thickness in a range from 0.1 μm to 50 μm, as an example, yet the thickness is not limited thereto. Accordingly, anti-reflective layer 30 and blue-transmitting dichroic multi-layer film 40 are not elements for supporting fluorescent substrate 10c.

### Advantageous Effects Yielded by Rotator

If the temperature of fluorescent substrate 10c is increased by being irradiated with excitation light L1, a phenomenon in which less fluorescence is generated (a so-called thermal quenching phenomenon) occurs, which is known. For example, if a thermal quenching phenomenon occurs in the fluorescence emitting module disclosed in PTL 1, a problem of a decrease in efficiency of light usage of the fluorescence emitting module, for instance, occurs since less fluorescence is emitted from the fluorescence generator.

Furthermore, fluorescence emitting module 1c according to the present embodiment includes rotator 100. In this manner, fluorescent substrate 10c, for instance, rotates about axis A1, thus generating air currents. Fluorescent substrate 10c is cooled by the generated air currents. In other words, heat dissipation of fluorescent substrate 10c enhances. Accordingly, a rise in temperature of fluorescent substrate 10c can be reduced, and thus a decrease in fluorescence can be reduced. Thus, efficiency of light usage of fluorescence emitting module 1c can be increased. Furthermore, a decrease in fluorescence is reduced, and thus a change in chromaticity of transmitted light L2 can be reduced. Accordingly, highly reliable fluorescence emitting module 1c can be produced.

### <Diameter of Fluorescent Substrate>

The diameter of fluorescent substrate 10c in a circular plate shape is preferably in a range from 30 mm to 90 mm, more preferably in a range from 35 mm to 70 mm, and yet more preferably in a range from 40 mm to 50 mm as examples, but the diameter is not limited thereto.

### Advantageous Effects of No Supporting Substrates

As described above, fluorescence emitting module 1c according to the present embodiment does not include an element for supporting fluorescent substrate 10c (for example, the transparent substrate for fluorescence disclosed in PTL 1), for instance. Thus, fluorescence emitting module 1c according to the present embodiment has a structure with no supporting substrates. Accordingly, unlike PTL 1, reflection of excitation light L1 (that is, loss of excitation light L1) at the interface between the substrate for fluorescence and the atmosphere does not occur. Loss of excitation light L1 at the interface does not occur, and thus excitation light L1 that enters fluorescent substrate 10c increases. As a result, fluorescence generated by the fluorescent material in fluorescent substrate 10c increases. Thus, efficiency of light usage of fluorescence emitting module 1c can be increased. Furthermore, fluorescence emitting module 1c does not include an element for supporting fluorescent substrate 10c, for instance, and thus the fluorescence generator disclosed in PTL 1 is not detached. Accordingly, highly reliable fluorescence emitting module 1c can be produced.

### Advantageous Effects Yielded by Blue-Transmitting Dichroic Multi-Layer Film

Since blue-transmitting dichroic multi-layer film 40 is provided, excitation light L1 that is blue light can reduce Fresnel reflection at the interface between the atmosphere and fluorescent substrate 10c which is caused when blue-transmitting dichroic multi-layer film 40 is not provided. Thus, blue-transmitting dichroic multi-layer film 40 can reduce loss of excitation light L1 due to being reflected. Since such blue-transmitting dichroic multi-layer film 40 is provided, excitation light L1 that enters fluorescent substrate 10c increases. As a result, fluorescence generated by the fluorescent material in fluorescent substrate 10c increases.

### Advantageous Effects Yielded by Sintered Fluorescent Substance

Furthermore, here, advantageous effects yielded by fluorescent substrate 10c consisting essentially of the sintered fluorescent substance are to be described.

For example, a transparent resin corresponds to a binder in PTL 1. Indices of refraction of many known binders including this transparent resin are different from an index of refraction of a fluorescent material such as YAG:Ce. Accordingly, when a fluorescent material such as YAG:Ce and a binder are combined, light scattering, for instance, occurs. In this case, loss of light, for instance, is caused due to the light scattering.

However, the sintered fluorescent substance according to the present embodiment requires almost no binder, as stated above. Accordingly, with the sintered fluorescent substance, loss of light due to light scattering is less likely to occur. Thus, since fluorescence emitting module 1c includes fluorescent substrate 10c consisting essentially of the sintered fluorescent substance, efficiency of light usage achieved by fluorescence emitting module 1c can be increased.

### <Bonding>

Note that rotator 100 and fluorescent substrate 10c are in contact with each other with an adhesive member being provided therebetween. As the material of rotator 100, Al that is light and highly heat-conductive is used, taking into consideration a load onto rotator 100 itself that is a motor and thermal conductivity. The outside diameter of rotator 100 is shorter than or equal to a length twice radius R. A silicone resin is used for the adhesive member, in order to reduce a difference between thermal expansion coefficients of rotator 100 and fluorescent substrate 10c. Note that another material such as Cu or Fe may be used as the material of rotator 100, and the adhesive member may also be another epoxy resin or a highly heat-conductive adhesive that includes nano Ag or nano Cu.

### <Diameter of Fluorescent Substrate>

Here, the inventors have examined efficiency of energy of transmitted light L2 and the diameter of fluorescent substrate 10c. The results of examinations are shown in FIG. 4B.

FIG. 4B illustrates efficiency of energy of transmitted light L2 according to the present embodiment. Here, the results of examinations of fluorescent substrate 10c having a diameter (indicated by φ in FIG. 4B) in a range from 5 mm to 90 mm are shown.

The lower horizontal axis indicates energy of excitation light L1. Here, the incident area through which excitation light L1 enters fluorescent substrate 10c is 2 mm², and thus the upper horizontal axis indicates a density (excitation density) of energy of excitation light L1 in the incident area.

The vertical axis indicates efficiency of energy of transmitted light L2. The vertical axis shows normalized values of transmitted light L2 for data items each indicating a diameter of fluorescent substrate 10c, on the assumption that 100% indicates energy of transmitted light L2 when excitation light L1 has energy of 0.5 W. Thus, for example, for data indicating fluorescent substrate 10c having a diameter of 5 mm, the vertical axis indicates normalized values on the assumption that 100% indicates energy of transmitted light L2 that exists from fluorescent substrate 10c having a diameter of 5 mm when excitation light L1 has energy of 0.5 W. Similarly, for data indicating fluorescent substrate 10c having a diameter of 30 mm, the vertical axis indicates normalized values on the assumption that 100% indicates energy of transmitted light L2 that exists from fluorescent substrate 10c having a diameter of 30 mm when excitation light L1 has energy of 0.5 W.

The greater energy of excitation light L1 is, the higher the temperature of fluorescent substrate 10c is, so that a thermal quenching phenomenon readily occurs. If a thermal quenching phenomenon occurs, energy of transmitted light L2 sharply decreases. As illustrated in FIG. 4B, data items of fluorescent substrate 10c having a diameter in a range from 5 mm to 65 mm have regions in which energy of transmitted light L2 sharply decreases. For example, data of fluorescent substrate 10c having a diameter of 30 mm exhibits such a region when the energy of excitation light L1 increases from 70 W to 100 W.

FIG. 4B shows that such a region shifts to a point at which the energy of excitation light L1 is higher, as the diameter of fluorescent substrate 10c is greater. Thus, FIG. 4B shows that a thermal quenching phenomenon does not readily occur as the diameter of fluorescent substrate 10c is greater. This can be explained as below.

Heat generated due to being irradiated with excitation light L1 is transferred from a region irradiated with excitation light L1 (for example, a position distant from center point C1 by radius R stated above) to a region not irradiated with excitation light L1. The greater the diameter of fluorescent substrate 10c is, the greater a region not irradiated with excitation light L1 is. The region not irradiated with excitation light L1 corresponds to a region to which heat is transferred from the region irradiated with excitation light L1. Thus, as the diameter of fluorescent substrate 10c is greater, heat generated by due to being irradiated with excitation light L1 is more readily transferred, and thus the temperature of fluorescent substrate 10c is not readily increased. As a result, a thermal quenching phenomenon does not readily occur. Hence, as the diameter of fluorescent substrate 10c is greater, highly efficient transmitted light L2 can be obtained in a region where energy of excitation light L1 is high.

Furthermore, the examinations of the inventors have made it apparent that excitation light L1 needs about 100 W of energy, to cause light source module 600 to output light having 15000 lm, for example. Note that light source module 600 is an optical module that includes fluorescence emitting module 1c and an optical element, for instance, which will be described in detail with reference to FIG. 4A.

As described above, the diameter of fluorescent substrate 10c is preferably in a range from 30 mm to 90 mm, more preferably in a range from 35 mm to 70 mm, and yet more preferably in a range from 40 mm to 50 mm.

Since the diameter of fluorescent substrate 10c is in the above range, when the energy of excitation light L1 is 100 W, highly efficient transmitted light L2 (for example, the efficiency is 90% or higher of the vertical axis in FIG. 4B) can be obtained.

Thus, the diameter of fluorescent substrate 10c is determined as appropriate, according to light output from light source module 600. Note that if the diameter of fluorescent substrate 10c is great, the size of light source module 600 increases. As a result, the size of a light emitting device such as projector 500 or an illumination device increases, and thus the quality of such a light emitting device as a product lowers.

Accordingly, for example, if light output from light source module 600 is 15000 lm as stated above, the diameter of fluorescent substrate 10c may be in a range from 40 mm to 50 mm.

### <Thickness of Fluorescent Substrate>

The thickness of fluorescent substrate 10c (that is, the length thereof in the z-axis direction) may be in a range from 50 μm to 700 μm. The thickness of fluorescent substrate 10c is preferably in a range from 80 μm to 500 μm, and more preferably in a range from 100 μm 300 μm.

The greater the thickness of fluorescent substrate 10c is, the higher the heat conductivity of fluorescent substrate 10c is, and thus heat dissipation of fluorescent substrate 10c enhances.

On the other hand, if the thickness of fluorescent substrate 10c is great, excitation light L1 is readily scattered in fluorescent substrate 10c. As a result, a light emission spot area of transmitted light L2 in fluorescent substrate 10c in the plan view increases. As a result, the sizes of optical elements such as lenses disposed on the optical paths of transmitted light L2 enormously increase in a projector, for example, so that a problem arises that, for instance, the size of the projector enormously increases, accordingly.

Furthermore, the greater the thickness of fluorescent substrate 10c is, the greater the volume of fluorescent substrate 10c is. As a result, more fluorescent material and more highly heat-conductive material are necessary to manufacture one fluorescent substrate 10c, which is disadvantageous in view of cost.

From the above, the thickness of fluorescent substrate 10c may be in the above range.

### [Examinations of Ce Concentration]

As described above, the fluorescent material according to the present embodiment is YAG:Ce ((Y₁₋ₓCeₓ)₃Al₅O₁₂) (0.0001≤x<0.1)). Here, the Ce concentration in YAG:Ce is to be described. The Ce concentration is an element proportion of Ce to a total of Y and Ce (stated differently, Ce/(Y+Ce) (%)), and is a numerical value of xx100(%).

### <Ce Concentration and Thickness>

First, a relation between the Ce concentration and the thickness of fluorescent substrate 10c is to be described.

The inventors examined how light output from light source module 600 (that is, transmitted light L2) illustrated in FIG. 4A is made while light as an example. More specifically, the inventors examined a relation between the Ce concentration in YAG:Ce and the thickness of fluorescent substrate 10c, to cause the chromaticity coordinates (x, y) of the output light to be in (a range from 0.308 to 0.318, a range from 0.324 to 0.334) in the CIE colorimetric system. The results of the examinations are shown in FIG. 5B. Note that the CIE colorimetric system is a colorimetric system determined by the International Commission on Illumination (CIE).

FIG. 5B illustrates a relation between the Ce concentration in YAG:Ce and the thickness of fluorescent substrate 10c according to the present embodiment.

In FIG. 5B, the vertical axis indicates the thickness of fluorescent substrate 10c, whereas the horizontal axis indicates the Ce concentration. Here, examinations are conducted at the Ce concentration of 0.01%, 0.05%, 0.1%, 0.2%, and 0.3%.

FIG. 5B illustrates three thicknesses of fluorescent substrate 10c at each of the Ce concentrations. At the Ce concentrations, since fluorescent substrate 10c has a thickness in a range of the above three thicknesses (more specifically, a range from the thinnest to the thickest), light output from light source module 600 is while light (that is, light having chromaticity coordinates in the above ranges). In other words, the chromaticity coordinates of light output from light source module 600 are in the above ranges by satisfying the relation between the Ce concentration in YAG:Ce and the thickness of fluorescent substrate 10c shown by FIG. 5B.

FIG. 5B shows that the thickness of fluorescent substrate 10c is greater as the Ce concentration is lower. In YAG:Ce according to the present embodiment, Ce functions as a luminescent center, and thus the lower the Ce concentration is, the less wavelength-converted light is generated. Accordingly, fluorescent substrate 10c is thicker as the Ce concentration is lower in order that the chromaticity coordinates of output light are in the above ranges.

The thicker fluorescent substrate 10c is, the lower a possibility that fluorescent substrate 10c is damaged is, since fluorescent substrate 10c is less likely to be cracked, for instance. Thus, the thicker fluorescent substrate 10c is, the more the reliability of fluorescent substrate 10c, that is, fluorescence emitting module 1c improves. For example, if the thickness of fluorescent substrate 10c is greater than or equal to 100 μm, the reliability of fluorescence emitting module 1c can be sufficiently improved. Accordingly, the Ce concentration may be lower than or equal to 0.1%.

Furthermore, examinations conducted with regard to a relation between the Ce concentration and the temperature of fluorescent substrate 10c are to be described with reference to FIG. 5C. Note that in the examinations, similarly to the above, a relation between the Ce concentration and the thickness of fluorescent substrate 10c illustrated in FIG. 5B is satisfied in order that the chromaticity coordinates of light output from light source module 600 fall within the above ranges.

### <Ce Concentration and Temperature>

FIG. 5C illustrates a relation between the Ce concentration in YAG:Ce and the temperature of fluorescent substrate 10c according to the present embodiment. More specifically, FIG. 5C illustrates temperatures of fluorescent substrate 10c when fluorescent substrate 10c is irradiated with excitation light L1 at the Ce concentrations. At this time, in light source module 600, fluorescent substrate 10c, for instance, is rotated at 7200 rpm. Note that as described above, in FIG. 5C, the relation between the Ce concentration and the thickness of fluorescent substrate 10c illustrated in FIG. 5B is satisfied. Thus, the lower the Ce concentration is, the greater the thickness of fluorescent substrate 10c is.

As illustrated in FIG. 5C, the lower the Ce concentration is, the lower the temperature of fluorescent substrate 10c is. As illustrated in FIG. 5B, the lower the Ce concentration is, the greater the thickness of fluorescent substrate 10c is, so that heat due to being irradiated with excitation light L1 is readily transferred. Accordingly, an increase in temperature of fluorescent substrate 10c can be reduced, as the Ce concentration is lower. Thus, the lower the Ce concentration is, the more a thermal quenching phenomenon can be prevented.

The inventors have clarified that it is necessary to maintain the temperature of fluorescent substrate 10c at 150 degrees Celsius or lower in order to fully prevent a thermal quenching phenomenon. Thus, from the view of preventing a thermal quenching phenomenon, the Ce concentration may be lower than or equal to 0.1%.

Furthermore, examinations conducted with regard to a relation between the Ce concentration and a spot size magnification are to be described. Note that in the examinations, similarly to the above, a relation between the Ce concentration and the thickness of fluorescent substrate 10c illustrated in FIG. 5B is satisfied in order that the chromaticity coordinates of light output from light source module 600 fall within the above ranges.

FIG. 5D illustrates a relation between the Ce concentration and a spot size magnification of fluorescent substrate 10c according to the present embodiment. The spot size magnification indicates a ratio between the incident area through which excitation light L1 enters and an exit area through which transmitted light L2 exits, within fluorescent substrate 10c. More specifically, the spot size magnification is a value indicated by the exit area/the incident area (%). The exit area has the same meaning as that of the above light emission spot area.

### <Ce Concentration and Spot Size>

As illustrated in FIG. 5D, the higher the Ce concentration is, the lower the spot size magnification is. As illustrated in FIG. 5B, the higher the Ce concentration is, the smaller the thickness of fluorescent substrate 10c is, and thus optical paths of excitation light L1 and wavelength-converted light are short. Accordingly, excitation light L1 and wavelength-converted light are less scattered in fluorescent substrate 10c. Thus, an increase in the spot size magnification can be reduced as the Ce concentration is higher.

As described in [Configuration of projector], if the light emission spot area of transmitted light L2 is great, the sizes of first optical element 301 and second optical element 302 that collect transmitted light L2 are enormously increased, and the size of projector 500 is enormously increased, accordingly. Conversely, the size of projector 500 can be reduced by decreasing the spot size magnification and the light emission spot area of transmitted light L2.

Furthermore, the inventors have clarified that the spot size magnification needs to be less than or equal to 250% in order to apply fluorescence emitting module 1c to projector 500, for example. Thus, the Ce concentration may be higher than or equal to 0.05%.

### <Summary>

As described above, from the examinations conducted by the inventors, the fluorescent material may be YAG:Ce ((Y₁₋ₓCeₓ)₃Al₅O₁₂) (0.0005≤x<0.001)) in which the Ce concentration is in a range from 0.05% to 0.1%.

Accordingly, a possibility that fluorescent substrate 10c is damaged is lower, and thus reliability of fluorescence emitting module 1c improves. In addition, a thermal quenching phenomenon in fluorescent substrate 10c can be reduced, and thus fluorescence emitting module 1c that achieves high efficiency of light usage can be produced. Furthermore, the size of projector 500 that is an example of a light emitting device can be reduced.

Note that the Ce concentration is preferably in a range from 0.06% to 0.09%, and more preferably in a range from 0.07% to 0.08%.

### [Manufacturing Method]

Here, a method for manufacturing fluorescent substrate 10c is to be briefly described.

A fluorescent material consists essentially of a crystalline phase represented by (Y_{0.999}Ce_{0.001})₃Al₅O₁₂. Further, the fluorescent material consists essentially of Ce³⁺ active fluorescent substance.

The following three raw materials are used as powdered chemical compounds to manufacture fluorescent substrate 10c. Specifically, the raw materials are Y₂O₃, Al₂O₃, and CeO₂. The purities and manufacturers of the raw materials are as follows: purity 3N and Nippon Yttrium Co., Ltd. for Y₂O₃, purity 3N and Sumitomo Chemical Co., Ltd. for Al₂O₃, and purity 3N and Nippon Yttrium Co., Ltd. for CeO₂.

Y₂O₃, Al₂O₃, and CeO₂ that are the raw materials are weighted to obtain a chemical compound of stoichiometry (Y_{0.999}Ce_{0.001})₃Al₅O₁₂. Next, the weighted raw materials and alumina balls (having a diameter of 10 mm) are put into a plastic pot. The amount of alumina balls is sufficient to fill about ⅓ of the volume of the plastic pot. After that, pure water is put into the plastic pot, and the raw materials and the pure water are mixed using a pot rotator (manufactured by Nitto Kagaku Co., Ltd., BALL MILL ANZ-51S). The raw materials and the pure water are mixed for 12 hours. Accordingly, a slurried mixed raw material is obtained.

The mixed raw material is granulated using a spray dryer. Note that when the material is granulated, polyvinyl alcohol is used as an adhesive (binder).

The granulated mixed raw material is temporarily molded into a cylinder using an electric hydraulic press (manufactured by Riken Seiki Co., Ltd., EMP-5) and a closed-end cylindrical metal mold. The pressure applied when the raw material is molded is set to 5 MPa.

Next, the temporarily molded raw material is firmly molded using a cold isostatic press. The pressure applied when the raw material is firmly molded is set to 300 MPa. Note that the raw material firmly molded is subjected to heat treatment (binder removal treatment) in order to remove the adhesive (binder) used when the raw material is granulated. The temperature for the heat treatment is set to 500 degrees Celsius. Furthermore, the time for the heat treatment is set to 10 hours.

The molded raw material subjected to the heat treatment is baked using a tube atmospheric furnace. The baking temperature is set to 1675 degrees Celsius. The baking time is set to 4 hours. The baking atmosphere is a mixed gas atmosphere of nitrogen and hydrogen.

The cylindrical baked product is sliced using a multi-wire saw. Further, the sliced baked product is ground to adjust the thickness of the baked product. By making this adjustment, the baked product becomes fluorescent substrate 10c.

### [Configuration of Projector]

Next, projector 500 is to be described. Fluorescence emitting module 1c having a configuration as described above is used in projector 500 illustrated in FIG. 3 and an illumination device (not illustrated). FIG. 3 is a perspective view illustrating an appearance of projector 500 according to the present embodiment. FIG. 10 is a schematic diagram illustrating a configuration of projector 500 according to the present embodiment. FIG. 4A is a schematic diagram illustrating fluorescence emitting module 1c in projector 500 according to the present embodiment. Note that in FIG. 4A, a portion of fluorescence emitting module 1c is shown in a cross sectional view, two light emitters 200 are shown in a side view, and internal components of rotator 100 are omitted, similarly to FIG. 9.

As illustrated in FIG. 10, projector 500 according to the present embodiment includes light source module 600. Similarly to a known projector, projector 500 includes homogeneous optical system 601, display element 602, light transmitter 603, and control circuit 604 that controls display element 602. Homogeneous optical system 601 includes two multi-lens arrays (MLAs). Display element 602 is a substantially flat element that controls and outputs, as a video, transmitted light L2 output from fluorescence emitting module 1c and passing through homogeneous optical system 601. In other words, display element 602 generates light for a video. Display element 602 is specifically a transmissive liquid crystal panel. Display element 602 separates transmitted light L2 into red light, green light, and blue light. After that, red light, green light, and blue light that are separated are optically modulated by portions of display element 602 for the red, green, and blue light. As a result, a video is generated, and wavelengths of the red light, the green light, and the blue light are combined by a cross prism (not illustrated) that is an RGB combiner. Light transmitter 603 is of a Tessar type. Transmitted light L2 output from fluorescence emitting module 1c is controlled by the elements in the order of homogeneous optical system 601, display element 602, and light transmitter 603, and becomes projection light that is to be enlarged and projected onto a screen, for example. Control circuit 604 controls display element 602, and is implemented by a microcomputer, for example, but may be implemented by a processor. Note that the configuration of projector 500 is not limited to this configuration, and homogeneous optical system 601 may be a kaleidoscope structure such as a light pipe. Homogeneous optical system 601 may not be provided in a projector and a light emitting device that do not need evenness of a projected image. Display element 602 may be a digital micromirror device (DMD) or a liquid crystal on silicon (LCOS). For example, display element 602 may be a reflective liquid crystal panel, or may be a digital light processing (DLP) panel that includes a DMD. Transmitted light L2 may not be separated into red light, green light, and blue light in a projector and a light emitting device that adopt a time-division method and a black-and-white method. Light transmitter 603 may be of another type, such as a Gauss type.

Furthermore, light source module 600 is an optical module that includes fluorescence emitting module 1c, first optical element 301, second optical element 302, and third optical element 303. Thus, projector 500 that is an example of a light emitting device includes fluorescence emitting module 1c.

First optical element 301, second optical element 302, and third optical element 303 are optical components that control optical paths of transmitted light L2 output from fluorescence emitting module 1c. As an example, first optical element 301, second optical element 302, and third optical element 303 are lenses that collect transmitted light L2. As described above, the greater the thickness of fluorescent substrate 10c is, the greater a light emission spot area of transmitted light L2 is due to being scattered. In this case, the sizes of first optical element 301, second optical element 302, and third optical element 303 are enormously increased, and accordingly, the size of projector 500 is also enormously increased. Accordingly, the light emission spot area of transmitted light L2 needs to be controlled, or stated differently, the thickness of fluorescent substrate 10c needs to be controlled.

As described above, fourth optical element 304 collects excitation light L1 output by two light emitters 200 and controls the optical paths.

Next, behavior of light in FIG. 4A is to be described.

Excitation light L1 emitted by light emitters 200 enters blue-transmitting dichroic multi-layer film 40 through fourth optical element 304. Furthermore, excitation light L1 enters fluorescent substrate 10c. A wavelength of a portion of excitation light L1 that has entered is converted by the fluorescent material, and the portion of excitation light L1 passes through fluorescent substrate 10c in the form of fluorescence. A wavelength of another portion of excitation light L1 that has entered is not converted by the fluorescent material, and the other portion of excitation light L1 passes through fluorescent substrate 10c. Transmitted light L2 passing through fluorescent substrate 10c is combined light that includes fluorescence that is yellow light and excitation light L1 that is blue light having a wavelength not converted, and is white light. Transmitted light L2 enters anti-reflective layer 30. Furthermore, transmitted light L2 is emitted from fluorescence emitting module 1c (more specifically, fluorescent substrate 10c), to have a substantially Lambertian light distribution.

Transmitted light L2 emitted from fluorescence emitting module 1c is collected by first optical element 301, second optical element 302, and third optical element 303, and exits therethrough. Note that first optical element 301, second optical element 302, and third optical element 303 may not collect transmitted light L2 emitted from fluorescence emitting module 1c. For example, first optical element 301, second optical element 302, and third optical element 303 may substantially collimate emitted transmitted light L2 or cause emitted transmitted light L2 to slightly spread out. An angle of radiation of transmitted light L2 exiting through first optical element 301, second optical element 302, and third optical element 303 may be an angle of radiation at which light efficiently travels in projector 500 and an illumination device in each of which fluorescence emitting module 1c is used.

Transmitted light L2 that has exited through first optical element 301, second optical element 302, and third optical element 303 (or stated differently, light output from light source module 600) travels toward homogeneous optical system 601. As described above, transmitted light L2 output from light source module 600 is controlled by the elements in the order of homogeneous optical system 601, display element 602, and light transmitter 603, and becomes projection light that is to be enlarged and projected onto a screen. Thus, transmitted light L2 is used as projection light output by projector 500.

In the present embodiment, a wavelength of a portion of excitation light L1 is converted by the fluorescent material, and the portion of excitation light L1 passes through fluorescent substrate 10c. A wavelength of another portion of excitation light L1 is not converted by the fluorescent material, and the other portion of excitation light L1 passes through fluorescent substrate 10c. In this manner, transmitted light L2 that has passed through fluorescent substrate 10c can be used as projection light, for example. Thus, fluorescence emitting module 1c that can be used as a light-transmissive fluorescent wheel can be produced.

In the present embodiment, projector 500 that is an example of a light emitting device includes fluorescence emitting module 1c that achieves high efficiency of light usage. Accordingly, projector 500 that achieves high efficiency of light usage can be produced.

### <Disposition>

As described above, transmitted light L2 exits through fluorescent substrate 10c, to have a substantially Lambertian light distribution. In order that transmitted light L2 exiting through fluorescent substrate 10c to have a substantially Lambertian light distribution is efficiently controlled, first optical element 301 needs to be disposed close to fluorescent substrate 10c. On the other hand, it is sufficient if fourth optical element 304 can collect excitation light L1 on fluorescent substrate 10c, and thus the distance between fluorescent substrate 10c and the exit surface of fourth optical element 304 can be made longer than the distance between fluorescent substrate 10c and the entrance surface of first optical element 301. (For example, at this time, the spot size of excitation light L1 on fluorescent substrate 10c is smaller than the spot size of transmitted light L2 on fluorescent substrate 10c.) Thus, rotator 100 may be disposed on the z-axis negative side of fluorescent substrate 10c to prevent rotator 100 and optical elements (first optical element 301, second optical element 302, third optical element 303, and fourth optical element 304) from interfering one another.

### Embodiment 2

### [Configuration of Fluorescence Emitting Module]

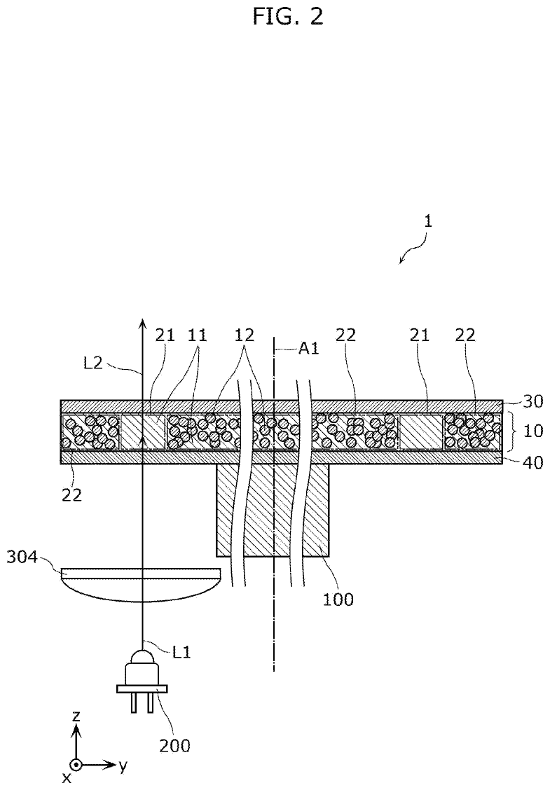

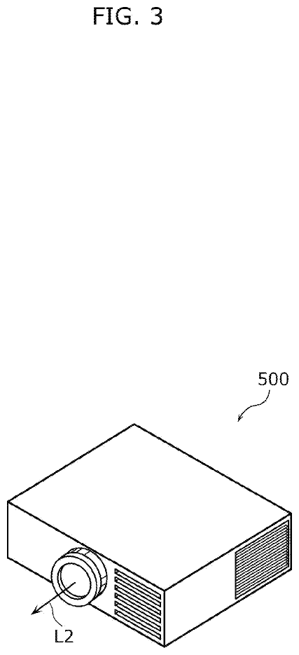

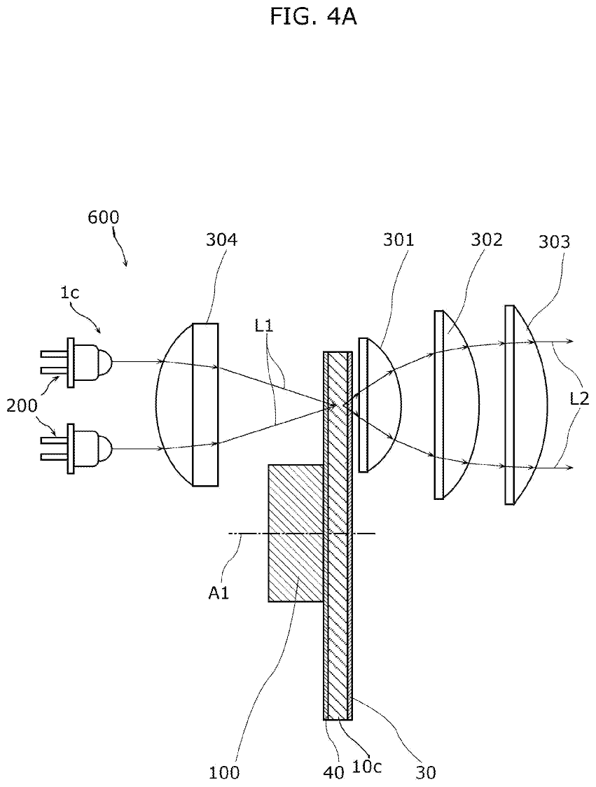

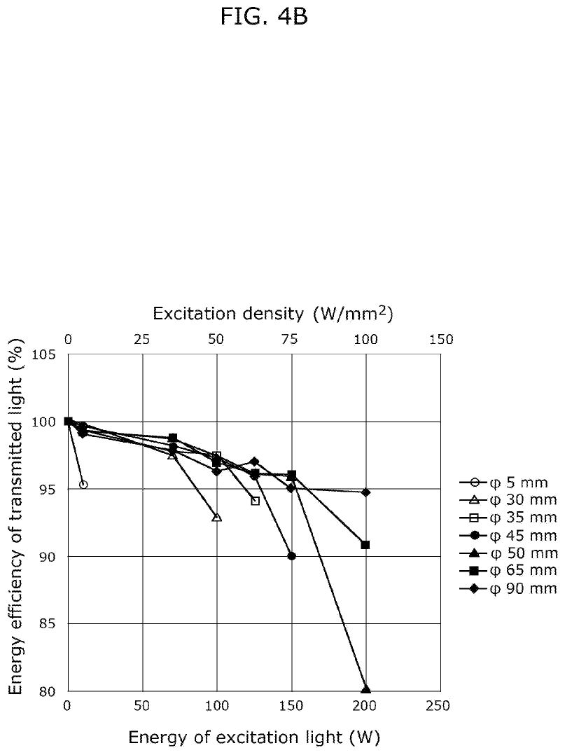

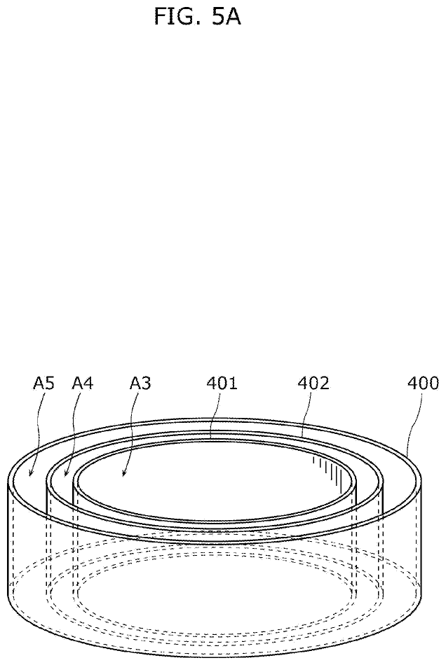

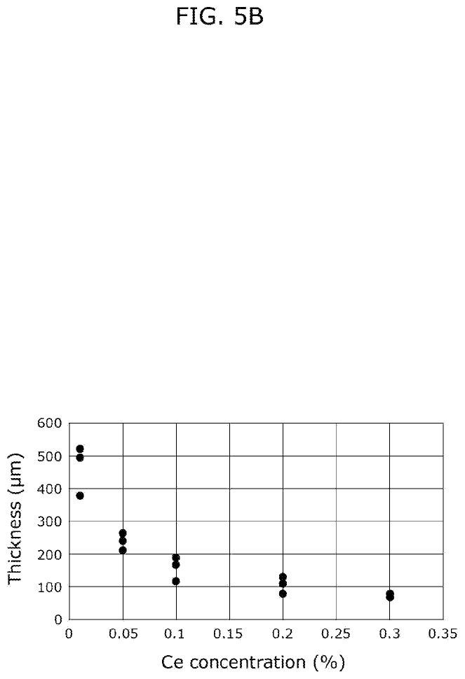

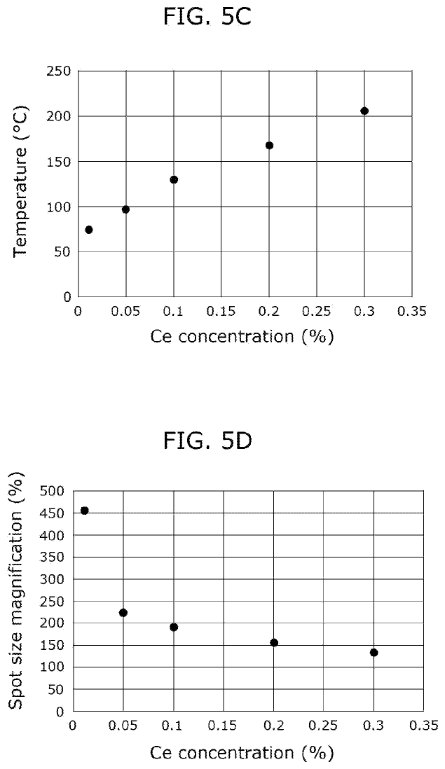

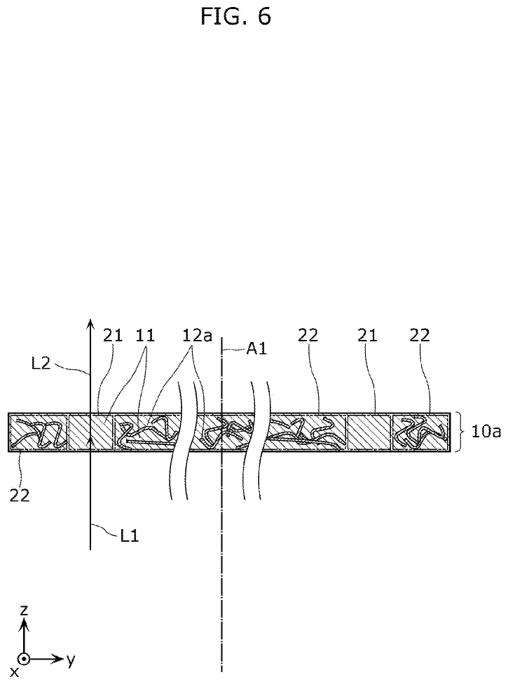

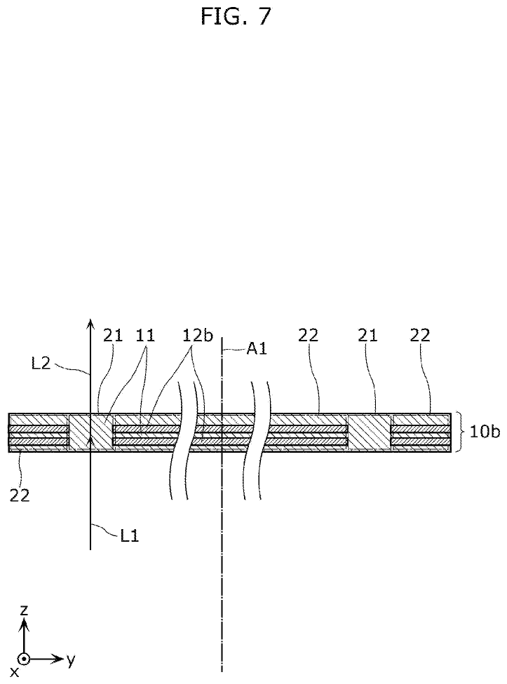

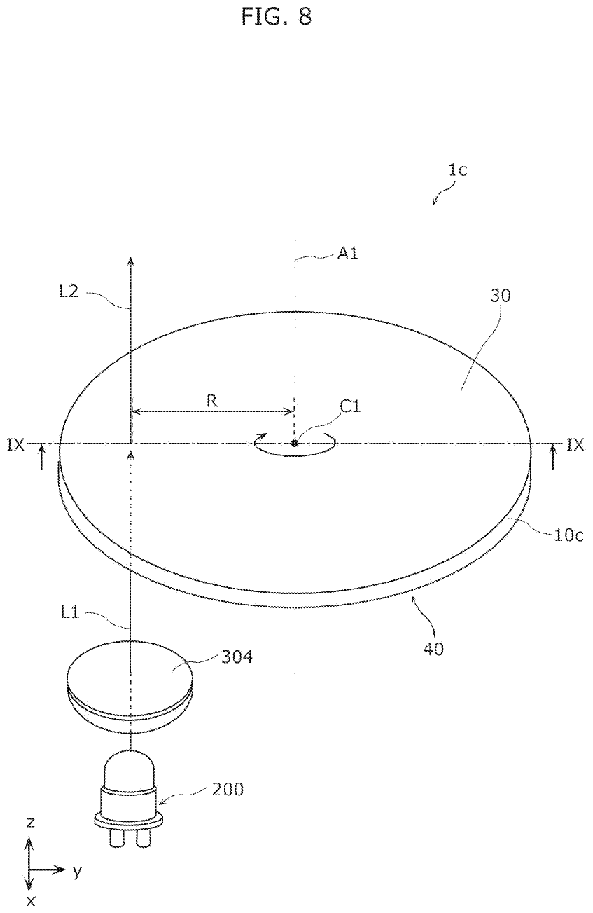

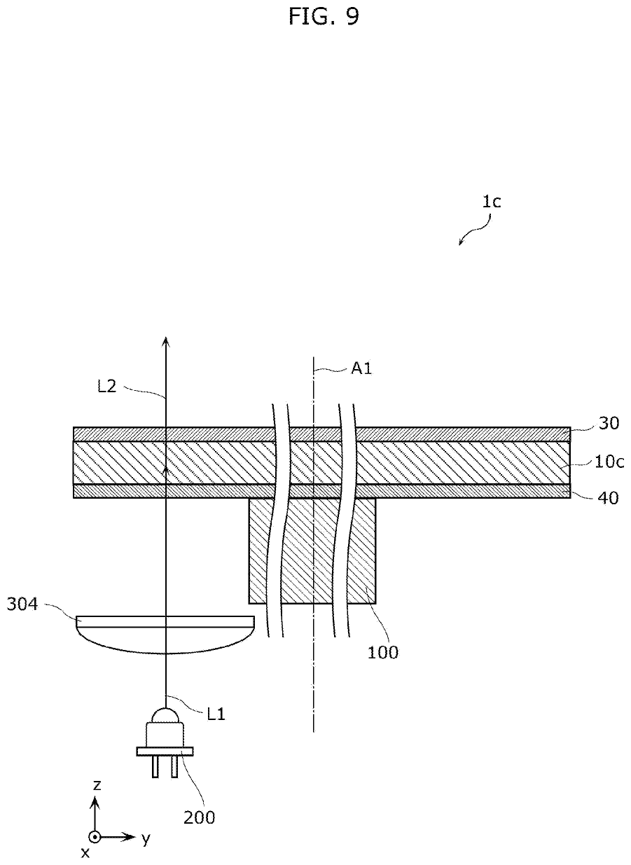

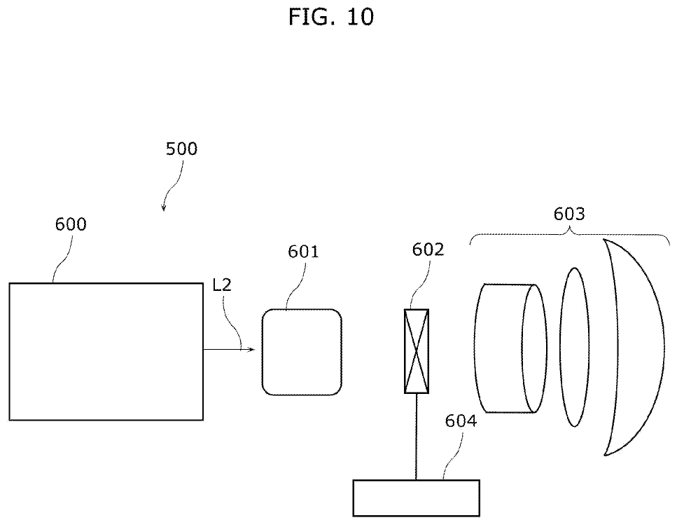

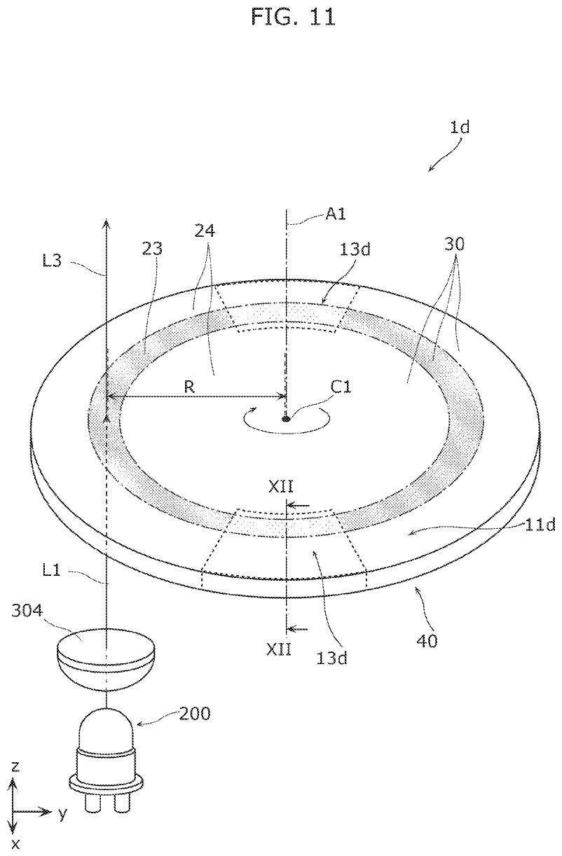

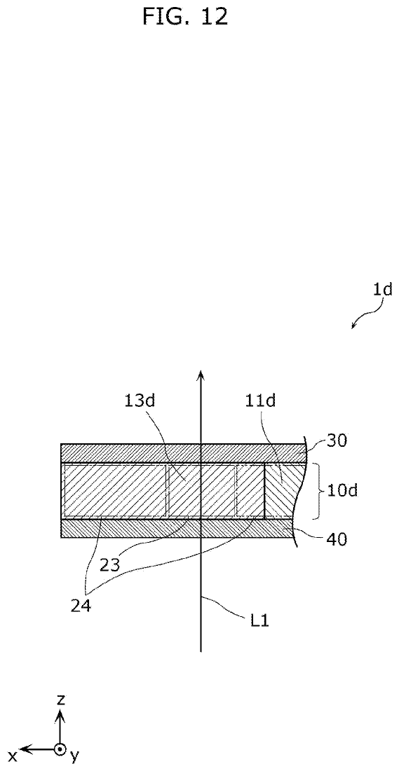

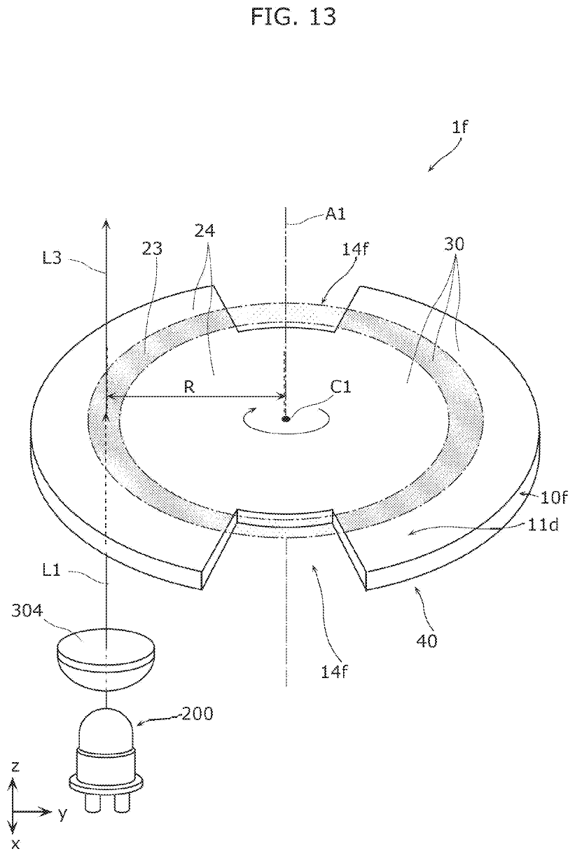

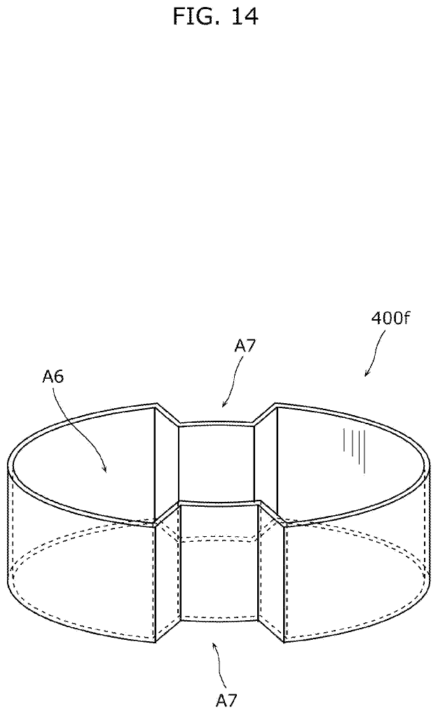

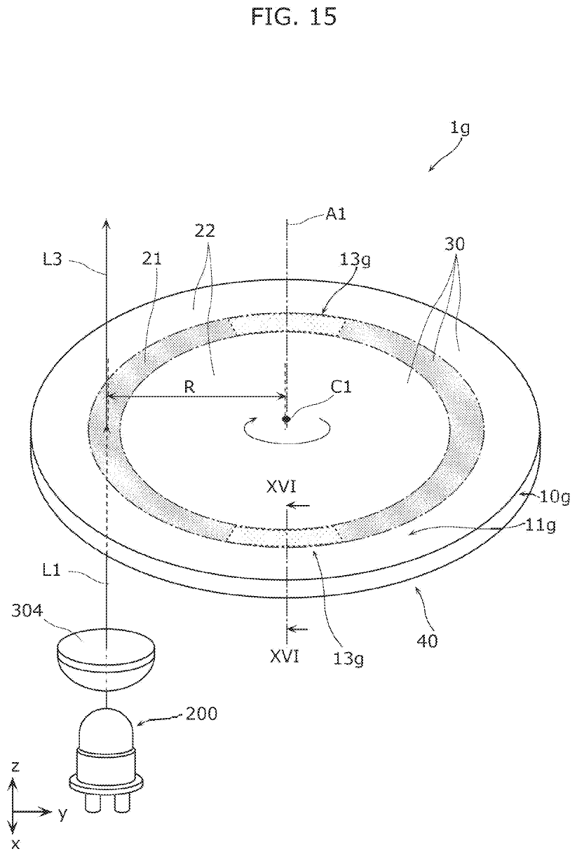

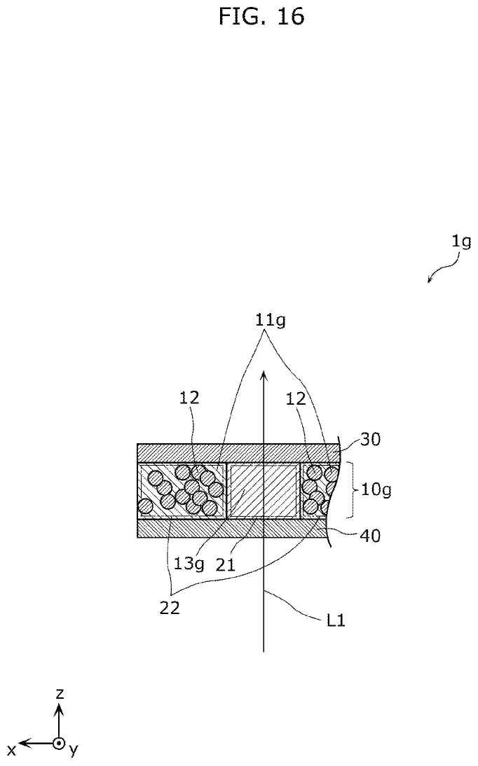

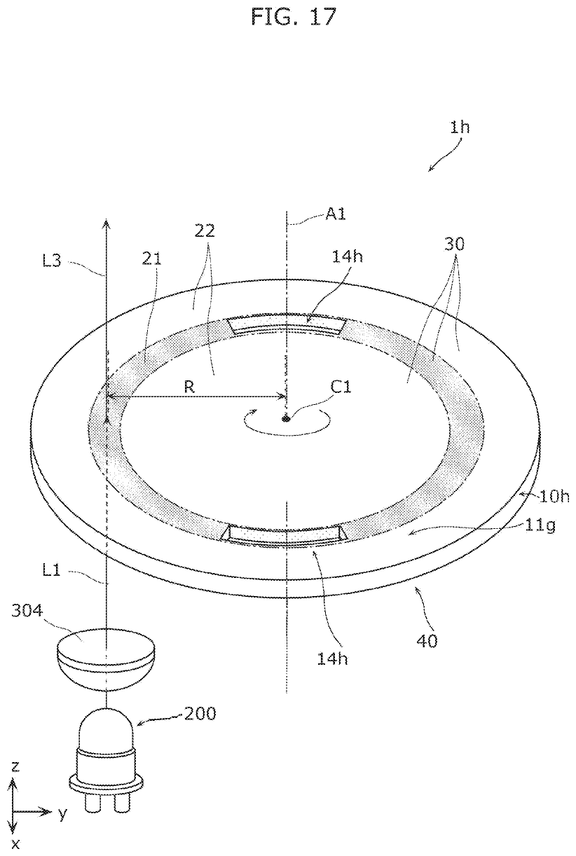

Next, fluorescence emitting module 1 according to Embodiment 2 is to be described with reference to FIG. 1 and FIG. 2. FIG. 1 is a perspective view of fluorescence emitting module 1 according to the present embodiment. FIG. 2 is a cross sectional view illustrating a cut surface of a portion of fluorescence emitting module 1 taken along line II-II in FIG. 1.

Fluorescence emitting module 1 includes fluorescent substrate consisting essentially of a sintered fluorescent substance, anti-reflective layer 30, blue-transmitting dichroic multi-layer film 40, rotator 100, and two light emitters 200. Note that FIG. 1 and FIG. 2 illustrate one light emitter 200 for convenience.

Thus, in the present embodiment, fluorescent substrate 10 is different from fluorescent substrate 10c according to Embodiment 1, in that fluorescent substrate 10 consists essentially of a sintered fluorescent substance that includes a fluorescent material and a highly heat-conductive material.

### <Description of Fluorescent Substrate>

Fluorescent substrate 10 is a circularly shaped substrate as described above, which consists essentially of a sintered fluorescent substance that includes a fluorescent material and a highly heat-conductive material. Thus, fluorescent substrate 10 has a disc shape having a flat surface. Specifically, here, fluorescent substrate 10 is made of a sintered fluorescent substance, and the sintered fluorescent substance is made of a fluorescent material and a highly heat-conductive material that are principal components.

More specifically, as illustrated in FIG. 2, fluorescent substrate 10 includes fluorescent structure 11 and a plurality of heat-conductive structures 12. Fluorescent structure 11 consists essentially of the fluorescent material included in the sintered fluorescent substance. Heat-conductive structures 12 consist essentially of the highly heat-conductive material included in the sintered fluorescent substance.

Note that here, the sintered fluorescent substance in the present embodiment is to be described.

A sintered fluorescent substance is a baked body obtained by baking raw-material powder of the fluorescent material and the highly heat-conductive material that are principal components (examples of which are granulated bodies obtained by granulating raw-material power of the materials) at a temperature lower than the melting points of the materials. During the baking process, raw-material powder particles of the sintered fluorescent substance are bonded. Accordingly, the sintered fluorescent substance requires almost no binder for bonding granulated bodies. More specifically, the sintered fluorescent substance does not need a binder at all. An example of a binder is a transparent resin in PTL 1 stated above. Further, a known material such as an Al₂O₃ material or a glass material (that is, SiO_{d} (0<d≤2)) is used for the binder. Note that similarly, not just the binder, the sintered fluorescent substance needs almost no material (hereinafter, another material) other than the fluorescent material and the highly heat-conductive material included in the sintered fluorescent substance, or more specifically, does not require none of such another material.

For example, when the entire volume of the sintered fluorescent substance is considered to be 100 vol %, a total of the volumes of the fluorescent material and the highly heat-conductive material may occupy 70 vol % or more of the entire volume of the sintered fluorescent substance. Further, a total of the volumes of the fluorescent material and the highly heat-conductive material occupies preferably 80 vol % or more, more preferably 90 vol % or more, or yet more preferably 95 vol % or more of the entire volume of the sintered fluorescent substance.

Note that stated differently, when the entire volume of the sintered fluorescent substance is considered to be 100 vol %, the volume of another material (for example, a binder) may occupy less than 30 vol % of the entire volume of the sintered fluorescent substance. Further, the volume of another material (for example, a binder) occupies preferably 20 vol % or less, more preferably 10 vol % or less, or yet more preferably 5 vol % or less of the entire volume of the sintered fluorescent substance.

### <Highly Heat-Conductive Material>

Next, heat-conductive structures 12 consisting essentially of the highly heat-conductive material are to be described. The shape of the highly heat-conductive material, or more specifically, the shapes of heat-conductive structures 12 are particle-shaped, for example. Heat-conductive structures 12 consisting essentially of the highly heat-conductive material are disposed being surrounded by fluorescent structure 11 in fluorescent substrate 10. Although not illustrated, heat-conductive structures 12 may be disposed in such a manner that heat-conductive structures 12 partially project out of fluorescent structure 11. Fluorescent structure 11 functions as a base material for heat-conductive structures 12. Thus, heat-conductive structures 12 are embedded in fluorescent structure 11. Some of heat-conductive structures 12 are in a state in which heat-conductive structures 12 are in contact with each other, that is, a so-called moniliform state. Particle-shaped heat-conductive structures 12 each have a diameter in a range from 1 μm to 100 μm, for example.

If the temperature of fluorescent substrate 10 is increased by being irradiated with excitation light L1, a phenomenon in which less fluorescence is generated (a so-called thermal quenching phenomenon) occurs, which is known. For example, if a thermal quenching phenomenon occurs in the fluorescence emitting module disclosed in PTL 1, a problem of a decrease in efficiency of light usage of the fluorescence emitting module, for instance, arises since less fluorescence is emitted from the fluorescence generator.

However, in the present embodiment, the sintered fluorescent substance includes a highly heat-conductive material, and thus a decrease in fluorescence can be reduced. Specifically, an explanation is given as follows.

The highly heat-conductive material is a material having a thermal conductivity in a range from 100 W/m·K to 300 W/m·K, and has a higher thermal conductivity than that of a fluorescent material such as YAG:Ce. Further, the thermal conductivity of the highly heat-conductive material is preferably in a range from 130 W/m·K to 200 W/m·K, and more preferably in a range from 145 W/m·K to 170 W/m·K. Since the sintered fluorescent substance included in fluorescent substrate 10 includes the highly heat-conductive material, heat generated in fluorescent substrate 10 is readily transferred. In other words, heat dissipation of fluorescent substrate 10 enhances. Accordingly, a rise in temperature of fluorescent substrate 10 due to being irradiated with excitation light L1 can be reduced, and thus a decrease in fluorescence can be reduced. Thus, fluorescence emitting module 1 that achieves high efficiency of light usage can be produced. Furthermore, a decrease in fluorescence is reduced, and thus a change in chromaticity of transmitted light L2 can be reduced. Accordingly, highly reliable fluorescence emitting module 1 can be produced.

Furthermore, heat-conductive structures 12 are each particle-shaped, and moreover, if heat-conductive structures 12 are in contact with each other, the heat is more readily conducted through heat-conductive structures 12, and thus heat dissipation of fluorescent substrate 10 can be further enhanced.

### <Types of Highly Heat-Conductive Material>

The highly heat-conductive material according to the present embodiment consists essentially of W, but nevertheless, may consist essentially of one or more metal elements as follows, for instance, in view of a thermal conductivity, a melting point, and a linear expansion coefficient, as another example.

The highly heat-conductive material includes at least one of Rh, Mo, W, SiC, and AlN, for example. The highly heat-conductive material may consist essentially of one or more metal elements selected from among the above materials, an alloy that includes one or more of the metal elements, or a chemical compound that includes one or more of the metal elements. The elements have thermal conductivity as follows: thermal conductivity of Rh is 150 W/m·K, thermal conductivity of Mo is 135 W/m·K, thermal conductivity of W is 163 W/m·K, thermal conductivity of SiC is 200 W/m·K, and thermal conductivity of AlN is 150 W/m·K.

The thermal conductivities of the highly heat-conductive materials are higher than 11.2 W/m·K that is a thermal conductivity of YAG:Ce included in the fluorescent material. Accordingly, the sintered fluorescent substance includes such highly heat-conductive materials, and thus heat dissipation of fluorescent substrate 10 can be enhanced.

Furthermore, the melting points of the highly heat-conductive materials at normal pressure may be in a range from 1700 degrees Celsius to 3500 degrees Celsius. For example, the melting points of the above metal elements and chemical compounds at normal pressure are: 1963 degrees Celsius for Rh, 2623 degrees Celsius for Mo, 3422 degrees Celsius for W, 2730 degrees Celsius for SiC, and 2200 degrees Celsius for AlN. When manufacturing fluorescent substrate 10, fluorescent substrate 10 may be subjected to a heat treatment (baking) at a high temperature (for example, 1650 degrees Celsius). In such a case, since the highly heat-conductive materials have melting points of 1700 degrees Celsius or higher at normal pressure, the highly heat-conductive materials are prevented from melting during the heat treatment. Accordingly, fluorescent substrate 10 consisting essentially of a sintered fluorescent substance that includes a fluorescent material and a highly heat-conductive material can be readily manufactured.

### <Thermal Expansion Coefficient>

The linear expansion coefficient of the highly heat-conductive material may be less than or equal to 1×10⁻⁷/K. The linear expansion coefficient of the highly heat-conductive material may be greater than or equal to 1×10⁻⁶/K. Thus, the linear expansion coefficient of the highly heat-conductive material has a value close to the linear expansion coefficient of the fluorescent material (the linear expansion coefficient of YAG:Ce is 8×10⁻⁶/K). For example, the linear expansion coefficients of the above metal elements and chemical compounds are: 8.2×10⁻⁶/K for Rh, 4.8×10⁻⁶/K for Mo, 4.5×10⁻⁶/K for W, 3.7×10⁻⁶/K for SiC, and 4.0×10⁻⁶/K for AlN. Since the linear expansion coefficients of the highly heat-conductive materials have the above values, the values are close to the linear expansion coefficient of the fluorescent material. Accordingly, even if the temperature of fluorescent substrate 10 increases due to being irradiated with excitation light L1, the fluorescent material and the highly heat-conductive material are prevented from being detached from each other. Accordingly, highly reliable fluorescence emitting module 1 can be produced.

### SUMMARY

To summarize the above, since the highly heat-conductive material is one of Rh, Mo, W, SiC, or AlN, the thermal conductivity, the linear expansion coefficient, and the melting point of the highly heat-conductive material satisfy the above values. Thus, heat dissipation of fluorescent substrate 10 enhances, and the fluorescent material and the highly heat-conductive material are prevented from being detached from each other. Thus, highly reliable fluorescence emitting module 1 that achieves high efficiency of light usage can be produced. In the manufacturing process of fluorescent substrate 10, the highly heat-conductive material is prevented from melting, and thus fluorescent substrate 10 can be readily manufactured.

### <Proportion of Highly Heat-Conductive Material>

In fluorescent substrate 10, a ratio between the fluorescent material and the highly heat-conductive material is as follows, as an example. If the volume of the fluorescent material is assumed to be 100, the volume of the highly heat-conductive material may be in a range from 1 to several tens. The greater the volume of the highly heat-conductive material is, the more heat dissipation of fluorescent substrate 10 can be enhanced. Since the volume of the highly heat-conductive material is in the above range, sufficient heat dissipation of fluorescent substrate 10 can be achieved.

### <Segmentation of Highly Heat Conduction>

Fluorescent substrate 10 according to the present embodiment includes first region 21 and one or more second regions 22. Thus, fluorescent substrate 10 according to the present embodiment is segmented into first region 21 and one or more second regions 22. More specifically, fluorescent substrate 10 includes first region 21 and plural second regions 22, in the plan view. Note that in FIG. 1, first region 21 is shown with dots, whereas in FIG. 2, first region 21 is shown by rectangle regions surrounded by the dash-dot lines, and second regions 22 are shown by rectangle regions surrounded by the two-dot chain lines.

First region 21 and second regions 22 have different contents of the highly heat-conductive material. Second regions 22 have a higher content of the highly heat-conductive material than the content thereof in first region 21. Thus, it is sufficient if first region 21 has a lower content of the highly heat-conductive material than a content thereof in second regions 22, and first region 21 in the present embodiment does not include the highly heat-conductive material. However, first region 21 may include the highly heat-conductive material. Excitation light L1 emitted by light emitters 200 enters first region 21.

If excitation light L1 enters the highly heat-conductive material (or more specifically, heat-conductive structures 12 consisting essentially of the highly heat-conductive material), excitation light L1 is scattered or absorbed by heat-conductive structures 12, and thus less fluorescence is generated. Thus, when fluorescent substrate 10 includes first region 21 and second regions 22, if excitation light L1 enters first region 21 having a lower content of the highly heat-conductive material, fluorescence generated in first region 21 increases. Thus, efficiency of light usage of fluorescence emitting module 1 can be further increased. Note that first region 21 may not include a highly heat-conductive material. Accordingly, efficiency of wavelength conversion by the fluorescent material can be increased.

As illustrated in FIG. 1, in the plan view of fluorescent substrate 10, the shape of first region 21 is an annular ring shape, and the center of the annular ring overlaps center point C1 of fluorescent substrate 10. First region 21 is provided in a circular ring shape on a circumference equally distant from center point C1 of fluorescent substrate 10. Thus, first region 21 is provided in a belt shape along the circumferential direction in the plan view.

Since the shape of first region 21 is such a shape as above, rotator 100 can more readily rotate fluorescent substrate 10 about axis A1. Accordingly, fluorescent substrate 10 can be more readily used as a fluorescent wheel.

Furthermore, in the plan view of fluorescent substrate 10, second regions 22 are provided on an inner side and an outer side of the annular ring shape that is the shape of first region 21. Note that second region 22 provided on the inner side out of second regions 22 is referred to as “inner second region 22”, and second region 22 provided on the outer side out of second regions 22 is referred to as “outer second region 22”.

The shape of inner second region 22 is a disc shape, and the center of the disc shape overlaps center point C1 of fluorescent substrate 10. Inner second region 22 is in contact with the inside surface of first region 21. The shape of outer second region 22 is an annular ring shape, similarly to the shape of first region 21, and the center of the annular ring shape overlaps center point C1 of fluorescent substrate 10. Outer second region 22 is in contact with the outside surface of first region 21. Thus, first region 21 is located between inner second region 22 and outer second region 22.

At this time, heat generated in first region 21 by being irradiated with excitation light L1 can be transferred to both of two second regions 22 between which first region 21 is located. In this case, heat dissipation of fluorescent substrate 10 can be enhanced, as compared with the case where fluorescence emitting module 1 includes second region 22 on only one of the inner side or the outer side of first region 21, for example. Accordingly, a rise in temperature of fluorescent substrate 10 can be reduced, and thus a decrease in fluorescence can be further reduced.

Furthermore, as illustrated in FIG. 1 and FIG. 2, fluorescent substrate 10 does not need to be supported by another element. Thus, fluorescent substrate 10 has a rigid property. Since fluorescent structure 11 is a sintered fluorescent substance and has a thickness in the above range, fluorescent substrate 10 has a rigid property. As compared with the fluorescence generator formed with a coating material that includes a fluorescent substance and a transparent resin, which is disclosed in PTL 1, fluorescent substrate according to the present embodiment is much more rigid.

Fluorescence emitting module 1 according to the present embodiment may be applied to projector 500, instead of fluorescence emitting module 1c according to Embodiment 1. Also in this case, excitation light L1 enters first region 21 included in fluorescent substrate 10. Accordingly, since excitation light L1 enters first region 21 having a lower content of the highly heat-conductive material, fluorescence can be increased and efficiency of light usage achieved by fluorescence emitting module 1 can be further increased.

Further, in this case, a wavelength of a portion of excitation light L1 that has entered is converted by the fluorescent material included in first region 21, and the portion of excitation light L1 passes through fluorescent substrate 10 in the form of fluorescence. A wavelength of another portion of excitation light L1 that has entered is not converted by the fluorescent material included in first region 21, and the other portion of excitation light L1 passes through fluorescent substrate 10. In this manner, transmitted light L2 that has passed through fluorescent substrate 10 can be used as projection light, for example. Thus, fluorescence emitting module 1 that can be used as a light-transmissive fluorescent wheel can be produced.

### Advantageous Effects Yielded by Highly Heat-Conductive Material

Furthermore, in the present embodiment, since the sintered fluorescent substance included in fluorescent substrate 10 includes a highly heat-conductive material, heat dissipation of fluorescent substrate 10 increases. Accordingly, a rise in temperature of fluorescent substrate 10 due to being irradiated with excitation light L1 can be reduced, and thus a decrease in fluorescence can be reduced. Hence, fluorescence emitting module 1 that achieves higher efficiency of light usage can be produced.

Since the sintered fluorescent substance included in fluorescent substrate 10 includes the highly heat-conductive material, heat dissipation of fluorescent substrate 10 increases, and a rise in temperature of fluorescent substrate 10 can be reduced. Thus, energy of excitation light L1 that can be received by a fluorescent wheel having a small size can be increased. Hence, a smaller light beam having a greater luminous flux can be emitted. As a specific example, a conventional size of a fluorescent wheel for use in a projector that outputs light having 6000 lm is φ 65 mm, yet W of 60 vol % is included as a highly heat-conductive material, and thus the size can be reduced to φ 50 mm.

To summarize the above, highly reliable fluorescence emitting module 1 that achieves high efficiency of light usage can be produced.

### [Manufacturing Method]

Here, a method for manufacturing fluorescent substrate 10 is to be briefly described.

A fluorescent material consists essentially of a crystalline phase represented by (Y_{0.999}Ce_{0.001})₃Al₅O₁₂. Further, the fluorescent material consists essentially of a Ce³⁺ active fluorescent substance.

The following four raw materials are used as powdered chemical compounds to manufacture fluorescent substrate 10. Specifically, the raw materials are Y₂O₃, Al₂O₃, CeO₂, and W. The purities and manufacturers of the raw materials are as follows: purity 3N and Nippon Yttrium Co., Ltd. for Y₂O₃, purity 3N and Sumitomo Chemical Co., Ltd. for Al₂O₃, purity 3N and Nippon Yttrium Co., Ltd. for CeO₂, and purity 4N and Kojundo Chemical Lab. Co., Ltd. for W.

Here, two mixed raw materials are used. The two mixed materials are a first mixed raw material that does not include W, and a second mixed raw material that includes W.

First, the first mixed raw material is to be described. Y₂O₃, Al₂O₃, and CeO₂ that are the raw materials are weighted to obtain a chemical compound of stoichiometry (Y_{0.999}Ce_{0.001})₃Al₅O₁₂. Next, the weighted raw materials and alumina balls (having a diameter of 10 mm) are put into a plastic pot. The amount of alumina balls is sufficient to fill about ⅓ of the volume of the plastic pot. After that, pure water is put into the plastic pot, and the raw materials and the pure water are mixed using a pot rotator (manufactured by Nitto Kagaku Co., Ltd., BALL MILL ANZ-51S). The raw materials and the pure water are mixed for 12 hours. Accordingly, a slurried first mixed raw material is obtained.

The first mixed raw material is granulated using a spray dryer. Note that when the raw material is granulated, an acrylic binder is used as an adhesive (a binder).

Next, the second mixed raw material is to be described. Y₂O₃, Al₂O₃, and CeO₂ that are the raw materials are weighted to obtain a chemical compound of stoichiometry Y₃(Al_{0.999}Cr_{0.001})₅O₁₂. Furthermore, when the volume of the fluorescent material to be fabricated is assumed to be 100, W is weighted to cause the volume of W to be 10. Next, Y₂O₃, Al₂O₃, CeO₂, and W that are weighted and alumina balls (having a diameter of 10 mm) are put into a plastic pot. The second mixed raw material is granulated by carrying out the procedure after that, similarly to the first mixed raw material.

Next, molding the first mixed raw material and the second mixed raw material is to be described with reference to FIG. 5A.

FIG. 5A is a perspective view of metal mold 400 for manufacturing fluorescent substrate 10 according to the present embodiment.

The granulated first and second mixed raw materials are temporarily molded into a cylinder using an electric hydraulic press (manufactured by Riken Seiki Co., Ltd., EMP-5) and closed-end cylindrical metal mold 400. The pressure applied when the raw materials are molded is set to 5 MPa. At this time, the first mixed raw material that does not include W is provided in sixth region A4 in metal mold 400, and the second mixed raw material that includes W is provided in fifth region A3 and seventh region A5 in metal mold 400.

As illustrated in FIG. 5A, first partition 401 and second partition 402 are provided inside of metal mold 400. First partition 401 and second partition 402 each have a cylindrical shape with no bottom. The diameter of first partition 401 is smaller than the diameter of second partition 402, and first partition 401 is provided inside of second partition 402. First partition 401 and second partition 402 consist essentially of a material (for example, a resin material) that is removed by a heat treatment, for instance.

Metal mold 400 is divided into three regions by first partition 401 and second partition 402. The three regions are fifth region A3 having a cylindrical shape and located in the center of metal mold 400, sixth region A4 having a cylindrical shape with no bottom and surrounding fifth region A3, and seventh region A5 having a cylindrical shape with no bottom and surrounding sixth region A4. Fifth region A3 is surrounded by first partition 401 and the bottom surface of metal mold 400. Sixth region A4 is surrounded by first partition 401, second partition 402, and the bottom surface of metal mold 400. Seventh region A5 is surrounded by second partition 402 and the bottom surface and the side surface of metal mold 400.

Next, the temporarily molded raw materials are firmly molded using a cold isostatic press. The pressure applied when the raw materials are firmly molded is set to 300 MPa.

The molded raw materials subjected to the heat treatment are baked using a tube atmospheric furnace. The baking temperature is set to 1675 degrees Celsius. The baking time is set to 4 hours. The baking atmosphere is a mixed gas atmosphere of nitrogen and hydrogen. Note that the adhesive used when granulating and the resin material used for first partition 401 and second partition 402 are decomposed and removed at about 500 degrees Celsius, for example, while the temperature is being increased.

The cylindrical baked product is sliced using a multi-wire saw. Further, the sliced baked product is ground to adjust the thickness of the baked product. By making this adjustment, the baked product becomes fluorescent substrate 10.

The first mixed raw material in sixth region A4 corresponds to first region 21 that fluorescent substrate 10 includes. The second mixed raw material in fifth region A3 corresponds to inner second region 22 that fluorescent substrate 10 includes, and the second mixed raw material in seventh region A5 corresponds to outer second region 22 that fluorescent substrate 10 includes.

Note that first partition 401 and second partition 402 described above may consist essentially of a metal material. In this case, after the first mixed raw material is provided in sixth region A4 and the second mixed raw material is provided in fifth region A3 and seventh region A5, first partition 401 and second partition 402 are pulled upward, for example, and removed. In this manner, the first mixed raw material can be retained in sixth region A4 and the second mixed raw material can be retained in fifth region A3 and seventh region A5.

### Embodiment 3

### [Configuration of Fluorescence Emitting Module]

Next, fluorescence emitting module 1d according to Embodiment 3 is to be described with reference to FIG. 11 and FIG. 12. FIG. 11 is a perspective view of fluorescence emitting module 1d according to the present embodiment. FIG. 12 is a cross sectional view illustrating a cut surface of a portion of fluorescence emitting module 1d taken along line XII-XII in FIG. 11.

Fluorescence emitting module 1d includes fluorescent substrate 10d consisting essentially of a sintered fluorescent substance, anti-reflective layer 30, blue-transmitting dichroic multi-layer film 40, a rotator (not illustrated), and two light emitters 200. Note that FIG. 11 and FIG. 12 illustrate one light emitter 200 for convenience. The rotator according to the present embodiment has the same configuration as that of rotator 100 described above. Furthermore, in FIG. 11, illustration of axis A1 on the z-axis negative side with respect to blue-transmitting dichroic multi-layer film 40 is omitted. Light emitters 200 each emit excitation light L1 as described above.

Fluorescence emitting module 1d according to the present embodiment is different from fluorescence emitting module 1c according to Embodiment 1 and fluorescence emitting module 1 according to Embodiment 2 mainly in that fluorescent substrate 10d consists essentially of a sintered fluorescent substance that includes a fluorescent material and an oxide material that does not include a luminescent center element.

Fluorescent substrate 10d is a circularly shaped substrate that consists essentially of a sintered fluorescent substance that includes a fluorescent material and an oxide material that does not include a luminescent center element. Thus, fluorescent substrate 10d has a disc shape having a flat surface. Fluorescent substrate 10d is made of a sintered fluorescent substance, and the sintered fluorescent substance is made of a fluorescent material and an oxide material that does not include a luminescent center element, which are principal components.

More specifically, as illustrated in FIG. 12, fluorescent substrate 10d includes fluorescent structure 11d and oxide structure 13d. Note that as illustrated in FIG. 11, fluorescent structure 11d and two oxide structures 13d are provided. Thus, fluorescent substrate 10d includes fluorescent structure 11d and two oxide structures 13d, and two oxide structures 13d have the same configuration. Two oxide structures 13d are regions surrounded by the dotted lines in FIG. 11.

Fluorescent structure 11d consists essentially of the fluorescent material included in the sintered fluorescent substance. More specifically, fluorescent structure 11d is made of the fluorescent material included in the sintered fluorescent substance.

Oxide structures 13d consist essentially of the oxide material that does not include a luminescent center element and is included in the sintered fluorescent substance. More specifically, oxide structures 13d are made of the oxide material that does not include a luminescent center element and is included in the sintered fluorescent substance. Oxide structures 13d are examples of a first light transmitting region included in fluorescent substrate 10d. The first light transmitting regions are made of an oxide material that does not include a luminescent center element, do not include the fluorescent material, and transmit light (excitation light L1) that excites the fluorescent material.

Fluorescent substrate 10d is circularly shaped, as described above. More specifically, fluorescent substrate 10d is circularly shaped by combining fluorescent structure 11d and two oxide structures 13d.

Here, oxide structures 13d are annular sectors in the plan view of fluorescent substrate 10d. Stated differently, oxide structures 13d each have a shape surrounded by two arcs and two straight lines. Note that the annular sector is a term having meanings such as an annular ring sector, a sector trapezoid, and a sector ring. Fluorescent structure 11d has a lacked circular shape that is a partially missing circular shape, in the plan view of fluorescent substrate 10d. Thus, fluorescent substrate 10d is disc-shaped by fitting oxide structures 13d into such missing parts of fluorescent structure 11d.

Here, as illustrated in FIG. 11, oxide structures 13d are disposed such that the circumference of fluorescent substrate 10d circularly shaped overlaps an outer arc (that is, an arc farther from axis A1) out of two arcs that define each oxide structure 13d, in the plan view of fluorescent substrate 10d.

Note that here, the sintered fluorescent substance in the present embodiment is to be described.

A sintered fluorescent substance is a baked body obtained by baking raw-material powder of the fluorescent material and the oxide material that does not include a luminescent center element, which are above-stated principal components (examples of which are granulated bodies obtained by granulating raw-material power of the materials), at a temperature lower than the melting points of the materials. During the baking process, raw-material powder particles of the sintered fluorescent substance are bonded. Accordingly, the sintered fluorescent substance requires almost no binder for bonding granulated bodies. More specifically, the sintered fluorescent substance does not need a binder at all. An example of a binder is a transparent resin in PTL 1 stated above. Further, a known material such as an Al₂O₃ material or a glass material (that is, SiO_{d} (0<d≤2)) is used for the binder. Note that similarly, not just the binder, the sintered fluorescent substance needs almost no material (hereinafter, another material) other than the fluorescent material and the oxide material that does not include a luminescent center element, which are included in the sintered fluorescent substance, or more specifically, does not require none of such another material.

For example, when the entire volume of the sintered fluorescent substance is considered to be 100 vol %, a total of the volumes of the fluorescent material and the oxide material that does not include a luminescent center element may occupy 70 vol % or more of the entire volume of the sintered fluorescent substance. Further, a total of the volumes of the fluorescent material and the oxide material that does not include a luminescent center element occupies preferably 80 vol % or more, more preferably 90 vol % or more, or yet more preferably 95 vol % or more of the entire volume of the sintered fluorescent substance.

Note that stated differently, when the entire volume of the sintered fluorescent substance is considered to be 100 vol %, the volume of another material (for example, a binder) may occupy less than 30 vol % of the entire volume of the sintered fluorescent substance. Further, the volume of another material (for example, a binder) occupies preferably 20 vol % or less, more preferably 10 vol % or less, or yet more preferably 5 vol % or less of the entire volume of the sintered fluorescent substance.

Fluorescent structure 11d that consists essentially of the fluorescent material receives light that enters fluorescent substrate 10d from the z-axis negative direction as excitation light L1, and emits fluorescence. More specifically, the fluorescent material included in fluorescent structure 11d is irradiated with light emitted by light emitters 200 as excitation light L1, and thus fluorescent structure 11d emits fluorescence as wavelength-converted light. Hence, the wavelength-converted light emitted from fluorescent structure 11d has a wavelength longer than the wavelength of excitation light L1.

The fluorescent material according to the present embodiment consists essentially of YAG:Ce similarly to Embodiment 1 and Embodiment 2, but may be another fluorescent material stated above. Thus, fluorescent structure 11d according to the present embodiment consists essentially of YAG:Ce.

In the present embodiment, wavelength-converted light emitted from the fluorescent material (YAG:Ce) included in fluorescent structure 11d includes fluorescence that is yellow light. For example, the fluorescent material absorbs light having a wavelength in a range from 380 nm to 490 nm, and emits fluorescence that is yellow light and has a peak wavelength in a range from 490 nm to 580 nm. Since the fluorescent material consists essentially of YAG:Ce, the fluorescent material can readily emit fluorescence having a peak wavelength in a range from 490 nm to 580 nm.

Note that in Embodiment 1 and Embodiment 2 described above, transmitted light L2 includes fluorescence that is yellow light having a converted wavelength and excitation light L1 that is blue light having a wavelength not converted, is light having a combination of such light, and is while light.

However, in the present embodiment, the wavelength of the entirety of excitation light L1 that enters fluorescent structure 11d is converted by the fluorescent material, and resultant excitation light L1 passes through fluorescent structure 11d. Accordingly, transmitted light L3 that has passed through fluorescent structure 11d includes only wavelength-converted light. Thus, transmitted light L3 is yellow light.

The oxide material that does not include a luminescent center element is an aluminum oxide (Al₂O₃), for example, but here is a non-light-emitting material resulting from removing a luminescent center element from the above fluorescent material. Note that Al₂O₃ that is used as an oxide material that does not include a luminescent center element is different from the above binder. The oxide material that does not include a luminescent center element is a material having a high transmittance in a wavelength range of excitation light L1.

In the present embodiment, the fluorescent material consists essentially of YAG:Ce, and the luminescent center element is Ce, for example. Accordingly, the non-light-emitting material resulting from removing the luminescent center element from the fluorescent material, which is used in the present embodiment, consists essentially of Y₃Al₁₅O₁₂ (that is, YAG). From the above, oxide structures 13d according to the present embodiment consist essentially of Y₃Al₅O₁₂ (that is, YAG).

Oxide structures 13d that consist essentially of Y₃Al₁₅O₁₂ transmit excitation light L1 that enters fluorescent substrate 10d from the z-axis negative direction. Unlike fluorescence structure 11d, oxide structures 13d do not convert the wavelength of excitation light L1. The transmittance of oxide structures 13d is preferably 50% or higher, more preferably 70% or higher, yet more preferably 80% or higher, and still more preferably 90% or higher in the wavelength range of excitation light L1. Thus, the wavelength range indicated by excitation light L1 does not change before and after excitation light L1 passes through oxide structures 13d, and here, excitation light L1 is blue light.

Fluorescent substrate 10d according to the present embodiment includes third region 23 and one or more fourth regions 24. Thus, fluorescent substrate 10d according to the present embodiment is segmented into third region 23 and one or more fourth regions 24. More specifically, fluorescent substrate 10d includes third region 23 and plural fourth regions 24, in the plan view. Note that in FIG. 11, third region 23 is shown with dots, whereas in FIG. 12, third region 23 is shown by a rectangle region surrounded by the dash-dot line, and fourth regions 24 are shown by rectangle regions surrounded by the two-dot chain lines.

Note that third region 23 has the same shape as that of first region 21 according to Embodiment 2, and fourth regions 24 have the same shapes as those of second regions 22 according to Embodiment 2. Note that as stated above, fluorescent substrate 10d does not include a highly heat-conductive material.

As illustrated in FIG. 11, in the plan view of fluorescent substrate 10d, the shape of third region 23 is an annular ring shape, and the center of the annular ring overlaps center point C1 of fluorescent substrate 10d. Third region 23 is provided in a circular ring shape on a circumference equally distant from center point C1 of fluorescent substrate 10d. Thus, third region 23 is provided in a belt shape along the circumferential direction in the plan view. Excitation light L1 emitted by light emitters 200 enters third region 23. More specifically, in the present embodiment, excitation light L1 is emitted onto a position at radius R from center point C1 of fluorescent substrate 10d, as illustrated in FIG. 11.

In the plan view of fluorescent substrate 10d, third region 23 includes oxide structures 13d (that is, the first light-transmitting regions). More specifically, in the plan view of fluorescent substrate 10d, third region 23 includes portions of oxide structures 13d and portions of fluorescent structure 11d. Note that in FIG. 11, out of the dotted region showing third region 23, portions of oxide structures 13d are provided in portions of third region 23 indicated by lighter dotted regions, and portions of fluorescent structure 11d are provided in portions of third region 23 indicated by darker dotted regions.

Out of excitation light L1 that has entered third region 23, a portion of excitation light L1 that enters oxide structures 13d passes through oxide structure 13d. Further, out of excitation light L1 that has entered third region 23, a wavelength of a portion of excitation light L1 that enters fluorescent structure 11d is converted, and the portion of excitation light L1 exits through as transmitted light L3 that is wavelength-converted light.

Furthermore, in the plan view of fluorescent substrate 10d, fourth regions 24 are provided on an inner side and an outer side of the annular ring shape that is a shape of third region 23. Note that fourth region 24 provided on the inner side out of fourth regions 24 is referred to as “inner fourth region 24”, and fourth region 24 provided on the outer side out of fourth regions 24 is referred to as “outer fourth region 24”.

The shape of inner fourth region 24 is a disc shape, and the center of the disc shape overlaps center point C1 of fluorescent substrate 10d. Inner fourth region 24 is in contact with the inside surface of third region 23. The shape of outer fourth region 24 is an annular ring shape, similarly to the shape of third region 23, and the center of the annular ring shape overlaps center point C1 of fluorescent substrate 10d. Outer fourth region 24 is in contact with the outside surface of third region 23. Thus, third region 23 is located between inner fourth region 24 and outer fourth region 24.

In the present embodiment, the sintered fluorescent substance further includes an oxide material that does not include a luminescent center element. Fluorescent substrate 10d includes first light-transmitting regions that are made of the oxide material, do not include the fluorescent material, and transmit light (excitation light L1) that excites the fluorescent material.

Accordingly, when excitation light L1 enters the first light-transmitting regions (that is, oxide structures 13d) that consist essentially of the oxide material that does not include a luminescent center element, excitation light L1 passes through oxide structures 13d, and thus excitation light L1 exits through fluorescent substrate 10d. Similarly, when excitation light L1 enters fluorescent structure 11d that consists essentially of the fluorescent material, a wavelength of excitation light L1 is converted by fluorescent structure 11d, and thus transmitted light L3 that is wavelength-converted light exits through fluorescent substrate 10d.

Thus, rotation of the rotator allows excitation light L1 and wavelength-converted light to exit through fluorescent substrate 10d in a time-dividing manner. In the present embodiment, fluorescent substrate 10d can cause yellow light as excitation light L1 and blue light as wavelength-converted light to exit through in a time-dividing manner.

Furthermore, fluorescence emitting module 1d according to the present embodiment may be applied to projector 500, instead of fluorescence emitting module 1c according to Embodiment 1. In this case, projector 500 includes a digital lighting processing (DLP) element serving as display element 602, and thus can be used as a 1-DLP (1-Chip DLP) projector.

In the present embodiment, the oxide material is an aluminum oxide or a non-light-emitting material resulting from removing a luminescent center element from the fluorescent material.

These materials have high transmittance of excitation light L1 (that is, light that excites the fluorescent material). Accordingly, the transmittance of excitation light L1 in the first light-transmitting regions (oxide structures 13d) is high, and loss of excitation light L1 due to being absorbed is reduced. Thus, fluorescence emitting module 1d that achieves high efficiency of light usage can be produced.

In the present embodiment, in the plan view of fluorescent substrate 10d, fluorescent substrate 10d includes third region 23 that is in an annular ring shape, the center of the annular ring shape overlaps the center (center point C1) of fluorescent substrate 10d, and third region 23 includes the first light-transmitting regions. Furthermore, in the present embodiment, third region 23 also includes fluorescent structures 11d.

Since third region 23 has the shape as stated above, when excitation light L1 enters third region 23, fluorescent substrate 10d that allows excitation light L1 and wavelength-converted light to exit therethrough in a time-dividing manner can be more readily used as a fluorescent wheel.

In the present embodiment, fluorescence emitting module 1d further includes light emitters 200 that each emit excitation light L1 that enters third region 23 and excites the fluorescent material.

In this manner, since excitation light L1 enters third region 23 that includes fluorescent structure 11d and oxide structures 13d, fluorescent substrate 10d more readily allows excitation light L1 and wavelength-converted light to exit therethrough in a time-dividing manner.

Note that two oxide structures 13d are provided in the present embodiment, but the number thereof is not limited thereto. For example, single oxide structure 13d may be provided or three or more oxide structures 13d may be provided.

As another example of the present embodiment, if the fluorescent material consists essentially of a fluorescent material other than the fluorescent material represented by (Y₁₋ₓCeₓ)₃Al₅O₁₂ (0.0001≤x<0.1), a non-light-emitting material resulting from removing a luminescent center element from the fluorescent material may be used. Thus, for example, if the fluorescent material consists essentially of (Lu_{1-y}Ce_{y})₃Al₂Al₃O₁₂ (0.001≤y<0.1), a non-light-emitting material resulting from removing a luminescent center element from the fluorescent material may consist essentially of Lu₃Al₅O₁₂.

### [Manufacturing Method]

Here, a method for manufacturing fluorescent substrate 10d is to be briefly described.

A fluorescent material consists essentially of a crystalline phase represented by (Y_{0.999}Ce_{0.001})₃Al₅O₁₂. Further, the fluorescent material consists essentially of a Ce³⁺ active fluorescent substance.

The following three raw materials are used as powdered chemical compounds to manufacture fluorescent substrate 10d. Specifically, the raw materials are Y₂O₃, Al₂O₃, and CeO₂. The purities and manufacturers of the raw materials are as follows: purity 3N and Nippon Yttrium Co., Ltd. for Y₂O₃, purity 3N and Sumitomo Chemical Co., Ltd. for Al₂O₃, and purity 3N and Nippon Yttrium Co., Ltd. for CeO₂.

Here, two mixed raw materials are used. The two mixed raw materials are a first mixed raw material that includes CeO₂, and a third mixed raw material that does not include CeO₂. Note that the first mixed raw material according to the present embodiment is the same as the first mixed raw material according to Embodiment 2, and thus description of the processes up to granulating the first mixed raw material is omitted.

First, the third mixed raw material is to be described. Y₂O₃ and Al₂O₃ that are the raw materials are weighted to obtain a chemical compound of stoichiometry Y₃Al₁₅O₁₂. Next, Y₂O₃ and Al₂O₃ that are weighted and alumina balls (having a diameter of 10 mm) are put into a plastic pot. The third mixed raw material is granulated by carrying out the procedure after that, similarly to the first mixed raw material.

Next, molding the first mixed raw material and the third mixed raw material is to be described.

Also in the manufacturing method according to the present embodiment, a cylindrical metal mold provided with partitions inside is used, similarly to Embodiment 2. Here, the metal mold is divided into three regions by two partitions. The first mixed raw material is provided in one region out of the three regions, and the third mixed raw material is provided in the other two regions out of the three regions. Note that in the plan view of the bottom surface of the cylindrical metal mold, the shapes of the two regions in which the third mixed raw material is provided are each an annular sector, and the shape of the one region in which the first mixed raw material is provided is a shape resulting from removing an annular sector from a circular shape. Thus, the two partitions are provided so that the first mixed raw material provided in the one region corresponds to fluorescent structure 11d, and the third mixed raw material provided in the other two regions corresponds to two oxide structures 13d.

Fluorescent substrate 10d is manufactured by performing the processing in the same manner as Embodiments 1 and 2 except that the shape of the metal mold differs.

### Embodiment 4

### [Configuration of Fluorescence Emitting Module]

Next, fluorescence emitting module 1f according to Embodiment 4 is to be described with reference to FIG. 13. FIG. 13 is a perspective view of fluorescence emitting module 1f according to the present embodiment.

Fluorescence emitting module 1f includes fluorescent substrate 10f consisting essentially of a sintered fluorescent substance, anti-reflective layer 30, blue-transmitting dichroic multi-layer film 40, a rotator (not illustrated), and two light emitters 200. Note that FIG. 13 illustrates one light emitter 200 for convenience. The rotator according to the present embodiment has the same configuration as that of rotator 100 described above. Light emitters 200 each emit excitation light L1 as described above.

Fluorescence emitting module 1f according to the present embodiment is different from fluorescence emitting module 1d according to Embodiment 3 mainly in that fluorescent substrate 10f includes second light-transmitting regions 14f instead of the first light-transmitting regions (oxide structures 13d). Thus, the sintered fluorescent substance according to the present embodiment consists essentially of the fluorescent material and does not include the oxide material that does not include a luminescent center element.

Fluorescent substrate 10f according to the present embodiment consists essentially of a sintered fluorescent substance that includes a fluorescent material. Fluorescent substrate 10f according to the present embodiment includes two second light-transmitting regions 14f, third region 23, and fourth regions 24. The sintered fluorescent substance according to the present embodiment consists essentially of fluorescent structure 11d described in Embodiment 3.

Second light-transmitting regions 14f are openings that fluorescent substrate 10f includes. Thus, second light-transmitting regions 14f are each at least one of a through-hole penetrating through fluorescent substrate 10f in the thickness direction (z-axis direction) of fluorescent substrate 10f or a notch provided in fluorescent substrate 10f. Here, second light-transmitting regions 14f correspond to notches. Second light-transmitting regions 14f have the same shapes as those of oxide structures 13d (the first light-transmitting regions) described in Embodiment 3.

Here, the sintered fluorescent substance in the present embodiment is to be described.

The sintered fluorescent substance is a baked body obtained by baking raw-material powder of the above fluorescent material that is a principal component (an example of which is a granulated body obtained by granulating raw-material power of the fluorescent material) at a temperature lower than the melting point of the fluorescent material. Thus, the sintered fluorescent substance according to the present embodiment is the same as the sintered fluorescent substance according to Embodiment 1.

As described in Embodiment 3, upon excitation light L1 entering fluorescent structure 11d, fluorescent structure 11d emits, as transmitted light L3, wavelength-converted light (yellow light) having a longer wavelength than the wavelength of excitation light L1.

Upon excitation light L1 entering second light-transmitting regions 14f, second light-transmitting regions 14f transmit excitation light L1 that is blue light.

Fluorescent substrate 10f according to the present embodiment includes third region 23 and one or more fourth regions 24 into which fluorescent substrate 10f is segmented. More specifically, fluorescent substrate 10f includes third region 23 and plural fourth regions 24, in the plan view. Note that in FIG. 13, third region 23 is given with dots.

Excitation light L1 emitted by light emitters 200 enters third region 23. More specifically, as illustrated in FIG. 13, in the present embodiment, excitation light L1 is emitted onto a position at radius R from center point C1 of fluorescent substrate 10f.

In the plan view of fluorescent substrate 10f, third region 23 includes second light-transmitting regions 14f. More specifically, in the plan view of fluorescent substrate 10f, third region 23 includes portions of second light-transmitting regions 14f and portions of fluorescent structure 11d. Note that in FIG. 13, out of the dotted region indicating third region 23, portions of second light-transmitting regions 14f are provided in portions of third region 23 indicated by lighter dotted regions, and portions of fluorescent structure 11d are provided in portions of third region 23 indicated by darker dotted regions.

In the present embodiment, fluorescent substrate 10f includes second light-transmitting regions 14f that transmit light (excitation light L1) that excites the fluorescent material. Second light-transmitting regions 14f are each at least one of a through-hole penetrating through fluorescent substrate 10f in the thickness direction of fluorescent substrate 10f or a notch provided in fluorescent substrate 10f.

Accordingly, when excitation light L1 enters second light-transmitting regions 14f, excitation light L1 exits through fluorescent substrate 10f. Similarly, when excitation light L1 enters fluorescent structure 11d that consists essentially of the fluorescent material, a wavelength of excitation light L1 is converted by fluorescent structure 11d, and thus transmitted light L3 that is wavelength-converted light exits through fluorescent substrate 10f.

Thus, rotation of the rotator allows excitation light L1 and wavelength-converted light to exit through fluorescent substrate 10f in a time-dividing manner. In the present embodiment, fluorescent substrate 10f can cause yellow light as excitation light L1 and blue light as wavelength-converted light to exit through in a time-dividing manner.

Furthermore, fluorescence emitting module if according to the present embodiment may be applied to projector 500, instead of fluorescence emitting module 1c according to Embodiment 1. In this case, projector 500 includes a digital lighting processing (DLP) element serving as display element 602, and thus can be used as a 1-DLP (1-Chip DLP) projector.

In the present embodiment, in the plan view of fluorescent substrate 10f, fluorescent substrate 10f includes third region 23 that is in an annular ring shape, the center of the annular ring shape overlaps the center (center point C1) of fluorescent substrate 10f, and third region 23 includes second light-transmitting regions 14f.

Furthermore, in the present embodiment, third region 23 also includes fluorescent structure 11d.

Since third region 23 has the above-stated shape, when excitation light L1 enters third region 23, fluorescent substrate 10f that allows excitation light L1 and wavelength-converted light to exit therethrough in a time-dividing manner can be more readily used as a fluorescent wheel.

In the present embodiment, fluorescence emitting module 1f further includes light emitters 200 that each emit excitation light L1 that enters third region 23 and excites the fluorescent material.

In this manner, since excitation light L1 enters third region 23 that includes fluorescent structure 11d and second light-transmitting regions 14f, fluorescent substrate 10f more readily allows excitation light L1 and wavelength-converted light to exit therethrough in a time-dividing manner.

### [Manufacturing Method]

Here, a method for manufacturing fluorescent substrate 10f is to be briefly described.

A fluorescent material consists essentially of a crystalline phase represented by (Y_{0.999}Ce_{0.001})₃Al₅O₁₂. Further, the fluorescent material consists essentially of a Ce³⁺ active fluorescent substance.

In order to manufacture fluorescent substrate 10f, similarly to the above, the first mixed raw material is granulated.

Next, molding the first mixed raw material is to be described with reference to FIG. 14.

FIG. 14 is a perspective view of metal mold 400f for manufacturing fluorescent substrate 10f according to the present embodiment.

Metal mold 400f is provided with inner region A6 and two notch regions A7.

The granulated first mixed raw material is temporarily molded using an electric hydraulic press (manufactured by Riken Seiki Co., Ltd., EMP-5) and closed-end cylindrical metal mold 400. The first mixed raw material is provided in inner region A6 in metal mold 400f.

Next, the temporarily molded raw material is firmly molded using a cold isostatic press.

The molded raw material subjected to the heat treatment is baked using a tube atmospheric furnace.

The cylindrical baked product is sliced using a multi-wire saw. Further, the sliced baked product is ground to adjust the thickness of the baked product. By making this adjustment, the baked product becomes fluorescent substrate 10f.

Note that the temporarily molding process, the firmly molding process, the baking process, the slicing process, and the grinding process are performed under the same conditions as those of Embodiment 1.

Since metal mold 400f provided with such two notch regions A7 is used, fluorescent substrate 10f that includes two second light-transmitting regions 14f.

### Embodiment 5

Next, fluorescence emitting module 1g according to Embodiment 5 is to be described with reference to FIG. 15 and FIG. 16. FIG. 15 is a perspective view of fluorescence emitting module 1g according to the present embodiment. FIG. 16 is a cross sectional view illustrating a cut surface of a portion of fluorescence emitting module 1g taken along line XVI-XVI in FIG. 15.

Fluorescence emitting module 1g includes fluorescent substrate 10g consisting essentially of a sintered fluorescent substance, anti-reflective layer 30, blue-transmitting dichroic multi-layer film 40, a rotator (not illustrated), and two light emitters 200. Note that FIG. 15 and FIG. 16 illustrate one light emitter 200 for convenience. The rotator according to the present embodiment has the same configuration as that of rotator 100 described above. Furthermore, in FIG. 15, illustration of axis A1 on the z-axis negative side with respect to blue-transmitting dichroic multi-layer film 40 is omitted. Light emitters 200 each emit excitation light L1 as described above.

Fluorescence emitting module 1g according to the present embodiment is different from fluorescence emitting modules 1c, 1, 1d, and if according to Embodiments 1, 2, 3, and 4, respectively, mainly in the following one point. Specifically, the one point is that fluorescent substrate 10g consists essentially of a sintered fluorescent substance that includes a fluorescent material, an oxide material that does not include a luminescent center element, and a highly heat-conductive material.

Fluorescent substrate 10g is a circularly shaped substrate that consists essentially of a sintered fluorescent substance that includes a fluorescent material, an oxide material that does not include a luminescent center element, and a highly heat-conductive material. Thus, fluorescent substrate 10g has a disc shape having a flat surface. Fluorescent substrate 10g is made of a sintered fluorescent substance, and the sintered fluorescent substance is made of a fluorescent material, an oxide material that does not include a luminescent center element, and a highly heat-conductive material, which are principal components.

More specifically, as illustrated in FIG. 16, fluorescent substrate 10g includes fluorescent structure 11g, oxide structures 13g, and a plurality of heat-conductive structures 12. Note that as illustrated in FIG. 15 and FIG. 16, fluorescent structure 11g, two oxide structures 13g, and heat-conductive structures 12 are provided. Thus, fluorescent substrate 10g includes fluorescent structure 11g, two oxide structures 13g, and heat-conductive structures 12, and two oxide structures 13g have the same configuration. Two oxide structures 13g are regions surrounded by the dotted lines in FIG. 15.

Fluorescent structure 11g consists essentially of the fluorescent material included in the sintered fluorescent substance. More specifically, fluorescent structure 11g is made of the fluorescent material included in the sintered fluorescent substance. Note that fluorescent structure 11g according to the present embodiment has the same configuration as that of fluorescent structure 11d according to embodiment 3 except for its shape.

Oxide structures 13g consist essentially of the oxide material that does not include a luminescent center element and is included in the sintered fluorescent substance. More specifically, oxide structures 13g are made of the oxide material that does not include a luminescent center element and is included in the sintered fluorescent substance. Note that oxide structures 13g according to the present embodiment have the same configuration as that of oxide structures 13d according to Embodiment 3 except for their shapes. Thus, oxide structures 13g are examples of a first light transmitting region included in fluorescent substrate 10g.

Fluorescent substrate 10g is circularly shaped, as described above. More specifically, fluorescent substrate 10g is circularly shaped by combining fluorescent structure 11g, two oxide structures 13g, and heat-conductive structures 12.

Here, oxide structures 13g are annular sectors in the plan view of fluorescent substrate 10g. Stated differently, oxide structures 13g each have a shape surrounded by two arcs and two straight lines.

Here, as illustrated in FIG. 15, two oxide structures 13g are disposed such that an outer arc (that is, an arc farther from axis A1) out of two arcs that define each oxide structure 13g is closer to axis Al than the circumference of fluorescent substrate 10g circularly shaped, in the plan view of fluorescent substrate 10g.

In the plan view of fluorescent substrate 10g, the shape of a combination of fluorescent structure 11g and heat-conductive structures 12 is a circular shape provided with two openings that are annular sectors. Thus, oxide structures 13g are fit in the openings to make fluorescent substrate 10g a disc shape, in the shape of the combination of fluorescent structure 11g and heat-conductive structures 12.

Heat-conductive structures 12 are provided in fluorescent substrate 10g in such a manner that heat-conductive structures 12 are surrounded by fluorescent structure 11g. Although not illustrated, heat-conductive structures 12 may be disposed in such a manner that heat-conductive structures partially project out of fluorescent structure 11g. Fluorescent structure 11g functions as a base material for heat-conductive structures 12. Thus, heat-conductive structures 12 are embedded in fluorescent structure 11g.

On the other hand, heat-conductive structures 12 are not provided in oxide structure 13g in fluorescent substrate 10g. As illustrated in FIG. 16, heat-conductive structures 12 and oxide structure 13g are not in contact with one another.

Note that here, the sintered fluorescent substance in the present embodiment is to be described.

The sintered fluorescent substance is a baked body obtained by baking raw-material powder of the fluorescent material, the oxide material that does not include a luminescent center element, and the highly heat-conductive material which are the above-stated principal components (examples of which are granulated bodies obtained by granulating raw-material power of the materials) at a temperature lower than the melting points of the materials. During the baking process, raw-material powder particles of the sintered fluorescent substance are bonded. Accordingly, the sintered fluorescent substance requires almost no binder for bonding granulated bodies. More specifically, the sintered fluorescent substance does not need a binder at all. An example of a binder is a transparent resin in PTL 1 stated above. Further, a known material such as an Al₂O₃ material or a glass material (that is, SiO_{d} (0<d≤2)) is used for the binder. Note that similarly, not just the binder, the sintered fluorescent substance needs almost no material (hereinafter, another material) other than the fluorescent material, the oxide material that does not include a luminescent center element, and the highly heat-conductive material, which are included in the sintered fluorescent substance, or more specifically, does not require none of such another material.

For example, when the entire volume of the sintered fluorescent substance is considered to be 100 vol %, a total of the volumes of the fluorescent material, the oxide material that does not include a luminescent center element, and the highly heat-conductive material may occupy 70 vol % or more of the entire volume of the sintered fluorescent substance. Further, a total of the volumes of the fluorescent material, the oxide material that does not include a luminescent center element, and the highly heat-conductive material occupies preferably 80 vol % or more, more preferably 90 vol % or more, or yet more preferably 95 vol % or more of the entire volume of the sintered fluorescent substance.

Note that stated differently, when the entire volume of the sintered fluorescent substance is considered to be 100 vol %, the volume of another material (for example, a binder) may occupy less than 30 vol % of the entire volume of the sintered fluorescent substance. Further, the volume of another material (for example, a binder) occupies preferably 20 vol % or less, more preferably 10 vol % or less, or yet more preferably 5 vol % or less of the entire volume of the sintered fluorescent substance.

Fluorescent substrate 10g according to the present embodiment includes first region 21 and one or more second regions 22. Thus, fluorescent substrate 10g according to the present embodiment is segmented into first region 21 and one or more second regions 22. More specifically, fluorescent substrate 10g includes first region 21 and plural second regions 22, in the plan view. Note that in FIG. 1, first region 21 is shown with dots, whereas in FIG. 16, first region 21 is shown by a rectangle region surrounded by the dash-dot line, and second regions 22 are shown by rectangle regions surrounded by the two-dot chain lines.

First region 21 and second regions 22 have different contents of the highly heat-conductive material. Second regions 22 have a higher content of the highly heat-conductive material than the content thereof in first region 21. Thus, it is sufficient if first region 21 has a lower content of the highly heat-conductive material than a content thereof in second regions 22, and first region 21 in the present embodiment does not include the highly heat-conductive material. However, first region 21 may include the highly heat-conductive material. Excitation light L1 emitted by light emitters 200 enters first region 21. More specifically, as illustrated in FIG. 15, in the present embodiment, excitation light L1 is emitted onto a position at radius R from center point C1 of fluorescent substrate 10g.

In the plan view of fluorescent substrate 10g, first region 21 includes oxide structures 13g (that is, the first light-transmitting regions). More specifically, in the plan view of fluorescent substrate 10g, first region 21 includes portions of oxide structures 13g and portions of fluorescent structure 11g. Note that in FIG. 15, out of the dotted region indicating first region 21, portions of oxide structures 13g are provided in portions of first region 21 indicated by lighter dotted regions, and portions of fluorescent structure 11g are provided in portions of first region 21 indicated by darker dotted regions.

Out of excitation light L1 that has entered first region 21, a portion of excitation light L1 that enters oxide structures 13g passes through oxide structures 13g. Further, out of excitation light L1 that has entered first region 21, a wavelength of a portion of excitation light L1 that enters fluorescent structure 11g is converted by fluorescent structure 11g, and the portion of excitation light L1 exits through as transmitted light L3 that is wavelength-converted light.

In the present embodiment, the sintered fluorescent substance further includes an oxide material that does not include a luminescent center element. Fluorescent substrate 10g includes first light-transmitting regions that consist essentially of the oxide material, do not include the fluorescent material, and transmit light (excitation light L1) that excites the fluorescent material. First region 21 includes the first light-transmitting regions.

Accordingly, when excitation light L1 enters the first light-transmitting regions (that is, oxide structures 13g) that consist essentially of the oxide material that does not include a luminescent center element, excitation light L1 passes through oxide structures 13g, and thus excitation light L1 exits through fluorescent substrate 10g. Similarly, when excitation light L1 enters fluorescent structure 11g that consists essentially of the fluorescent material, a wavelength of excitation light L1 is converted by fluorescent structure 11g, and thus transmitted light L3 that is wavelength-converted light exits through fluorescent substrate 10g.

Thus, rotation of the rotator allows excitation light L1 and wavelength-converted light to exit through fluorescent substrate 10g in a time-dividing manner. In the present embodiment, fluorescent substrate 10g can cause yellow light as excitation light L1 and blue light as wavelength-converted light to exit through in a time-dividing manner.

Furthermore, fluorescence emitting module 1g according to the present embodiment may be applied to projector 500, instead of fluorescence emitting module 1c according to Embodiment 1. In this case, projector 500 includes a digital lighting processing (DLP) element serving as display element 602, and thus can be used as a 1-DLP (1-Chip DLP) projector.

In the present embodiment, the oxide material is an aluminum oxide or a non-light-emitting material resulting from removing a luminescent center element from the fluorescent material.

These materials have high transmittance of excitation light L1 (that is, light that excites the fluorescent material). Accordingly, the transmittance of excitation light L1 in the first light-transmitting regions (oxide structures 13g) is high, and loss of excitation light L1 due to being absorbed is reduced. Thus, fluorescence emitting module 1g that achieves high efficiency of light usage can be produced.

### Embodiment 6

Next, fluorescence emitting module 1h according to Embodiment 6 is to be described with reference to FIG. 17. FIG. 17 is a perspective view of fluorescence emitting module 1h according to the present embodiment.

Fluorescence emitting module 1h includes fluorescent substrate 10h consisting essentially of a sintered fluorescent substance, anti-reflective layer 30, blue-transmitting dichroic multi-layer film 40, a rotator (not illustrated), and two light emitters 200. Note that FIG. 17 illustrates one light emitter 200 for convenience. The rotator according to the present embodiment has the same configuration as that of rotator 100 described above. Light emitters 200 each emit excitation light L1 as described above.

Fluorescence emitting module 1h according to the present embodiment is different from fluorescence emitting module 1g according to Embodiment 5 mainly in that fluorescent substrate 10h includes second light-transmitting regions 14h instead of the first light-transmitting regions (oxide structures 13g). Thus, the sintered fluorescent substance according to the present embodiment is made of a fluorescent material and a highly heat-conductive material, and does not include an oxide material that does not include a luminescent center element.

Thus, fluorescent substrate 10h according to the present embodiment consists essentially of a sintered fluorescent substance that includes a fluorescent material. Fluorescent substrate 10h according to the present embodiment includes two second light-transmitting regions 14h, first region 21, and second regions 22. The sintered fluorescent substance according to the present embodiment consists essentially of fluorescent structure 11g described in Embodiment 5.

Second light-transmitting regions 14h are openings that fluorescent substrate 10h includes. Thus, second light-transmitting regions 14h are each at least one of a through-hole penetrating through fluorescent substrate 10h in the thickness direction (the z-axis direction) of fluorescent substrate 10h or a notch provided in fluorescent substrate 10h. Here, second light-transmitting regions 14h correspond to notches. Note that second light-transmitting regions 14h according to the present embodiment have the same configuration as that of second light-transmitting regions 14f according to Embodiment 4, except for their shapes. Second light-transmitting regions 14h have the same shapes as those of oxide structures 13g (the first light-transmitting regions) described in Embodiment 5, but the shapes of second light-transmitting regions 14h are not limited thereto.

Here, the sintered fluorescent substance in the present embodiment is to be described.

A sintered fluorescent substance is a baked body obtained by baking raw-material powder of the fluorescent material and the highly heat-conductive material that are above-stated principal components (examples of which are granulated bodies obtained by granulating raw-material power of the materials) at a temperature lower than the melting points of the materials. Thus, the sintered fluorescent substance according to the present embodiment is the same as the sintered fluorescent substance according to Embodiment 2.

As described in Embodiment 5, upon excitation light L1 entering fluorescent structure 11g, fluorescent structure 11g emits, as transmitted light L3, wavelength-converted light (yellow light) having a longer wavelength than the wavelength of excitation light L1.

Upon excitation light L1 entering second light-transmitting regions 14h, second light-transmitting regions 14h transmit excitation light L1 that is blue light.

Fluorescent substrate 10h according to the present embodiment includes first region 21 and one or more second regions 22 into which fluorescent substrate 10h is segmented. More specifically, fluorescent substrate 10h includes first region 21 and plural second regions 22, in the plan view. Note that in FIG. 17, first region 21 is given with dots.

Excitation light L1 emitted by light emitters 200 enters first region 21. More specifically, as illustrated in FIG. 17, in the present embodiment, excitation light L1 is emitted onto a position at radius R from center point C1 of fluorescent substrate 10h.

In the plan view of fluorescent substrate 10h, first region 21 includes second light-transmitting regions 14h. More specifically, in the plan view of fluorescent substrate 10h, first region 21 includes portions of second light-transmitting regions 14h and portions of fluorescent structure 11g. Note that in FIG. 17, out of the dotted region indicating first region 21, portions of second light-transmitting regions 14h are provided in portions of first region 21 indicated by lighter dotted regions, and portions of fluorescent structure 11g are provided in portions of first region 21 indicated by darker dotted regions.

Fluorescent substrate 10h includes second light-transmitting regions 14h that transmit light (excitation light L1) that excites the fluorescent material. Second light-transmitting regions 14h are each at least one of a through-hole penetrating through fluorescent substrate 10h in the thickness direction of fluorescent substrate 10h or a notch provided in fluorescent substrate 10h. First region 21 includes second light-transmitting regions 14h.

Accordingly, when excitation light L1 enters second light-transmitting regions 14h, excitation light L1 exits through fluorescent substrate 10h. Similarly, when excitation light L1 enters fluorescent structure 11g that consists essentially of the fluorescent material, a wavelength of excitation light L1 is converted by fluorescent structure 11g, and thus transmitted light L3 that is wavelength-converted light exits through fluorescent substrate 10h.

Thus, rotation of the rotator allows excitation light L1 and wavelength-converted light to exit through fluorescent substrate 10h in a time-dividing manner. In the present embodiment, fluorescent substrate 10h can cause yellow light as excitation light L1 and blue light as wavelength-converted light to exit through in a time-dividing manner.

Furthermore, fluorescence emitting module 1h according to the present embodiment may be applied to projector 500, instead of fluorescence emitting module 1c according to Embodiment 1. In this case, projector 500 includes a digital lighting processing (DLP) element serving as display element 602, and thus can be used as a 1-DLP (1-Chip DLP) projector.

### Other Embodiments

The above has described, for instance, the fluorescence emitting modules according to the present invention, based on the embodiments, but nevertheless the present invention is not limited to those embodiments. The scope of the present invention includes various modifications, which may be conceived by those skilled in the art, to the embodiments or other forms constructed by combining some elements in the embodiments, without departing from the gist of the present invention.

Note that fluorescence emitting module 1/1c includes fluorescent substrate 10/10c, anti-reflective layer 30, blue-transmitting dichroic multi-layer film 40, rotator 100, and light emitters 200, yet the elements included therein are not limited thereto.

Fluorescence emitting module 1c may include fluorescent substrate 10c and rotator 100. Also in this case, unlike PTL 1, reflection of excitation light L1 at the interface between the substrate for fluorescence and the atmosphere does not occur. Thus, more excitation light L1 enters fluorescent substrate 10c. As a result, fluorescence generated by the fluorescent material in fluorescent substrate 10c increases. Further, fluorescence emitting module 1c does not include an element for supporting fluorescent substrate 10c, for instance, and thus the fluorescence generator disclosed in PTL 1 is not detached. Air currents are generated by rotator 100 rotating. With the generated air currents, a rise in temperature of fluorescent substrate 10c can be reduced, and thus a decrease in fluorescence can be reduced. Thus, efficiency of light usage of fluorescence emitting module 1c can be increased. Since a decrease in fluorescence is reduced, a change in chromaticity of transmitted light L2 can be reduced, and the above detachment does not occur. Accordingly, highly reliable fluorescence emitting module 1c can be produced.

Similarly, fluorescence emitting module 1 may include fluorescent substrate 10 that consists essentially of the sintered fluorescent substance that includes the fluorescent material and the highly heat-conductive material. Also in this case, unlike PTL 1, reflection of excitation light L1 at the interface between the substrate for fluorescence and the atmosphere does not occur. Thus, more excitation light L1 enters fluorescent substrate 10. As a result, fluorescence generated by the fluorescent material in fluorescent substrate 10 increases. Further, fluorescence emitting module 1 does not include, for instance, an element for supporting fluorescent substrate 10, and thus the fluorescence generator disclosed in PTL 1 is not detached. Further, since the sintered fluorescent substance included in fluorescent substrate 10 includes the highly heat-conductive material, heat dissipation of fluorescent substrate increases. Accordingly, a rise in temperature of fluorescent substrate 10 due to being irradiated with excitation light L1 can be reduced, and thus a decrease in fluorescence can be reduced. Hence, fluorescence emitting module 1 that achieves high efficiency of light usage can be produced. Since a decrease in fluorescence is reduced, a change in chromaticity of transmitted light L2 can be reduced, and the above detachment does not occur. Accordingly, highly reliable fluorescence emitting module 1 can be produced.

### <Shape of Heat-Conductive Structure>

In Embodiment 2, the shape of each heat-conductive structure 12 is particle-shaped, but as another example, may be wire-shaped, sheet-shaped, or mesh-shaped. Here, such other examples are to be described.

### <Mesh Shape>

FIG. 6 is a cross sectional view of fluorescent substrate 10a according to Another Example 1 of Embodiment 2. FIG. 7 is a cross sectional view of fluorescent substrate 10b according to Another Example 2 of Embodiment 2. Note that FIG. 6 and FIG. 7 each correspond to the cross sectional view in FIG. 2, and in FIGS. 6 and FIG. 7, elements such as anti-reflective layer 30, blue-transmitting dichroic multi-layer film 40, rotator 100, and light emitters 200 are omitted.

As illustrated in FIG. 6, when heat-conductive structures 12a are each wire-shaped, the line diameter is in a range from 1 μm to 50 μm, and the length is in a range from 10 μm to 500 μm as examples, yet the diameter and the length are not limited thereto.

### <Sheet Shape>

FIG. 7 illustrates an example in which heat-conductive structures 12b are each sheet-shaped. In this case, fluorescent structure 11 and heat-conductive structures 12b are stacked. On inner second region 22, heat-conductive structures 12b are circularly shaped, whereas on outer second region 22, conductive structures 12b are annular ring-shaped.

Although not illustrated, when the shape of each heat-conductive structure is a sheet shape, through-holes penetrating the sheet shape in the thickness direction may be provided. At this time, the shape of each heat-conductive structure is a mesh shape. Thus, the spaces in the mesh shape correspond to the above through-holes.

Since heat-conductive structures 12 have such shapes, heat dissipation of fluorescent substrates 10a and 10b can be further enhanced.

When heat-conductive structures are mesh-shaped, first region 21 may include heat-conductive structures. In this case, the heat-conductive structures may be provided in first region 21 and also in second regions 22. Accordingly, the structural strength of fluorescent substrate 10b can be increased, and thus fluorescent substrate 10b can be prevented from being cracked.

Note that first region 21 may not include the highly heat-conductive material, as described above. Accordingly, efficiency of wavelength conversion by the fluorescent material can be increased. Thus, first region 21 may have a lower content of the highly heat-conductive material than the content thereof in second regions 22.

Note that as illustrated in FIG. 11, oxide structures 13d are disposed such that the circumference of fluorescent substrate 10 circularly shaped overlaps an outer arc (that is, an arc farther from axis A1) out of two arcs that define each oxide structure 13d, in the plan view of fluorescent substrate 10d. However, the arrangement is not limited thereto.

For example, oxide structures 13d may be provided at the same positions as and in the same shapes as those of oxide structures 13g illustrated in FIG. 15.

In Embodiments 3 to 6, yellow light is emitted as transmitted light L3, yet transmitted light L3 is not limited thereto. For example, as the fluorescent material, YAG:Ce that is the yellow fluorescent material and a green fluorescent material may be used. In this case, the fluorescent substrate allows yellow light and green light as excitation light L1 and blue light as wavelength-converted light to exit therethrough in a time-dividing manner. Furthermore, for example, a red fluorescent material may be used instead of the green fluorescent material, for instance.

Various changes, replacement, addition, and omission, for instance, can be made to the above embodiments within the scope of the claims and the equivalents thereof.

### REFERENCE SIGNS LIST

1, 1c, 1d, 1f, 1g, 1h fluorescence emitting module
10, 10a, 10b, 10c, 10d, 10f, 10g, 10h fluorescent substrate
14f, 14h second light-transmitting region
21 first region
22 second region
23 third region
24 fourth region
100 rotator
200 light emitter
A1 axis
C1 center point
L1 excitation light
L2, L3 transmitted light
R radius

1. A fluorescence emitting module comprising:
a fluorescent substrate consisting essentially of a sintered fluorescent substance that includes a fluorescent material; and
a rotator that rotates the fluorescent substrate about an axis extending in a thickness direction of the fluorescent substrate.

2. The fluorescence emitting module according to claim 1,
wherein the sintered fluorescent substance further includes a highly heat-conductive material having a thermal conductivity in a range from 100 W/m·K to 300 W/m·K.

3. A fluorescence emitting module comprising:
a fluorescent substrate consisting essentially of a sintered fluorescent substance that includes:
a fluorescent material; and
a highly heat-conductive material having a thermal conductivity in a range from 100 W/m·K to 300 W/m·K.

4. The fluorescence emitting module according to claim 2,
wherein a linear expansion coefficient of the highly heat-conductive material is less than or equal to 1×10⁻⁷/K.

5. The fluorescence emitting module according to claim 2,
wherein the highly heat-conductive material includes at least one of W, Mo, Rh, AlN, or SiC.

6. The fluorescence emitting module according to claim 2,
wherein a melting point of the highly heat-conductive material at normal pressure is higher than or equal to 1700 degrees Celsius.

7. The fluorescence emitting module according to claim 2,
wherein a shape of the highly heat-conductive material is a particle shape, a wire shape, a sheet shape, or a mesh shape.

8. The fluorescence emitting module according to claim 2,
wherein in a plan view of the fluorescent substrate, the fluorescent substrate includes:
a first region; and
a second region in which a content of the highly heat-conductive material is higher than a content of the highly heat-conductive material in the first region.

9. The fluorescence emitting module according to claim 8,
wherein in the plan view of the fluorescent substrate,
a shape of the first region is an annular ring shape, and
a center of the annular ring shape overlaps a center of the fluorescent substrate.

10. The fluorescence emitting module according to claim 9,
wherein the sintered fluorescent substance further includes an oxide material that does not include a luminescent center element,
the fluorescent substrate includes a first light-transmitting region that transmits light that excites the fluorescent material, the first light-transmitting region consisting essentially of the oxide material and not including the fluorescent material, and
the first region includes the first light-transmitting region.

11. The fluorescence emitting module according to claim 10,
wherein the oxide material is an aluminum oxide or a non-light-emitting material resulting from removing the luminescent center element from the fluorescent material.

12. The fluorescence emitting module according to claim 9,
wherein the fluorescent substrate includes a second light-transmitting region that transmits light that excites the fluorescent material,
the second light-transmitting region is at least one of a through-hole or a notch provided in the fluorescent substrate, the through-hole penetrating through the fluorescent substrate in the thickness direction of the fluorescent substrate, and
the first region includes the second light-transmitting region.

13. The fluorescence emitting module according to claim 9,
wherein in the plan view of the fluorescent substrate, a plurality of second regions are provided on an inner side and an outer side of the annular ring shape, the plurality of second regions each being the second region.

14. The fluorescence emitting module according to claim 8, further comprising:
a light emitter that emits excitation light that enters the first region and excites the fluorescent material.

15. The fluorescence emitting module according to claim 14,
wherein a wavelength of a portion of the excitation light that has entered is converted by the fluorescent material included in the first region,
the portion of the excitation light having the wavelength converted passes through the fluorescent substrate,
a wavelength of an other portion of the excitation light that has entered is not converted by the fluorescent material included in the first region, and
the other portion of the excitation light having the wavelength not converted passes through the fluorescent substrate.

16. The fluorescence emitting module according to claim 1,
wherein the sintered fluorescent substance further includes an oxide material that does not include a luminescent center element, and
the fluorescent substrate includes a first light-transmitting region that transmits light that excites the fluorescent material, the first light-transmitting region consisting essentially of the oxide material and not including the fluorescent material.

17. The fluorescence emitting module according to claim 16,
wherein the oxide material is an aluminum oxide or a non-light-emitting material resulting from removing the luminescent center element from the fluorescent material.

18. The fluorescence emitting module according to claim 16,
wherein in a plan view of the fluorescent substrate,
the fluorescent substrate includes a third region that is in an annular ring shape,
substrate, and
a center of the annular ring shape overlaps a center of the fluorescent the third region includes the first light-transmitting region.

19. The fluorescence emitting module according to claim 1,
wherein the fluorescent substrate includes a second light-transmitting region that transmits light that excites the fluorescent material, and
the second light-transmitting region is at least one of a through-hole or a notch provided in the fluorescent substrate, the through-hole penetrating through the fluorescent substrate in the thickness direction of the fluorescent substrate.

20. The fluorescence emitting module according to claim 19,
wherein in a plan view of the fluorescent substrate,
the fluorescent substrate includes a third region that is in an annular ring shape,
a center of the annular ring shape overlaps a center of the fluorescent substrate, and
the third region includes the second light-transmitting region.

21. The fluorescence emitting module according to claim 18, further comprising:
a light emitter that emits excitation light that enters the third region, the excitation light being the light that excites the fluorescent material.

22. The fluorescence emitting module according to claim 1,
wherein the fluorescent material is represented by (Y₁₋ₓCeₓ)₃Al₅O₁₂, where 0.0005≤x<0.001.

23. A light emitting device comprising:
the fluorescence emitting module according to claim 1.
